(19) United States
(12) Patent Application Publication
(10) Pub. No.: US 2016/0129300 A1
(43) Pub. Date: May 12, 2016

(54) COVER OR TOWEL TO COVER EXERCISE MAT

(71) Applicant: Aviska Athletics, Inc., Los Angeles, CA (US)

(72) Inventors: Daniel Moore, New York, NY (US); Nivalda Pinguet, Los Angeles, CA (US)

(73) Assignee: Aviska Athletics, Inc., Los Angeles, CA (US)

(21) Appl. No.: 14/920,729

(22) Filed: Oct. 22, 2015

Related U.S. Application Data
(60) Provisional application No. 62/076,680, filed on Nov. 7, 2014.

(51) Int. Cl. A63B 21/00; B32B 3/06; B32B 7/08; B32B 1/08

(52) U.S. Cl. CPC A63B 21/4037; B32B 1/08; B32B 3/06; B32B 7/08; B32B 2307/744; B32B 2471/04

(57) ABSTRACT

A cover, such as a towel, for covering an article, such as a mat, is described. The cover may comprise a first surface, a second surface disposed opposite of the first surface, and an article attachment means. When the cover may be in use with the article, the first surface may be in removable physical contact with a user and the second surface may be substantially physically contacting the article. The article attachment means may comprise at least one segment of material that may be removably attached over a portion of the second surface to at least one edge of the cover forming a hollow tube or a cavity, wherein either an article terminal end or at least one article corner may removably pass through the hollow tube or be removably held within the cavity such that slippage between the cover and the article are minimized.

### PRIORITY NOTICE

The present application claims priority under 35 U.S.C. §119(e) to U.S. Provisional Patent Application Ser. No. 62/076,680 filed on Nov. 7, 2014, the disclosure of which is incorporated herein by reference in its entirety.

### TECHNICAL FIELD OF THE INVENTION

The present invention relates in general to covers for mats and more specifically to covers, such as towels, which may substantially cover an exercise mat, such as a yoga mat and/or a Pilates mat.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Presently certain exercises and wellness routines may be performed by a user on top of a mat, wherein the user and the mat may then be supported by some substrate, such as a floor or a ground. For example, when the user may be doing yoga and/or Pilates, such mats may often be used. In that context, such mats may be yoga mats and/or Pilates mats. Stretching and other various exercises may be done while the user may be on top of such mats. Such mats may generally be sized for individual use. Such mats may generally be portable and readily taken with the user and/or rolled up otherwise stored when not in use. Such mats may be used by the user for various reasons, including but not limited to, providing some cushioning to the user during exercising, stretching, and/or meditating, providing a barrier between the substrate and the user (because the substrate may be less than clean), and providing an exercise surface which may not slip against the substrate.

Presently a majority of such available mats may be constructed of polyvinyl chloride (PVC) and/or some other flexible and soft durometer plastic and/or elastomer. While such mats have alleviated some of the initial problems, such as providing a cushioning surface to work upon and a barrier between the user and the substrate, use of such mats, have created other problems. For example, such mats may become slippery to the user when wet. And mats often get wet from user sweat. Mat-user slipperiness then becomes a safety problem associated with most presently available mats. Additionally, such mats also tend to retain unpleasant smells and may also off gas offensive odors associated with the manufacturer of plastic and/or elastomeric based products. Such mats may also not have any fabric feel to the user which may be undesirable for some users who prefer a fabric like feel.

To solve these and other problems created by mat use, the art has largely responded by use of various towels to be used in conjunction with the mat. So that the user may then be on top of the towel, which in turn may be on top of the mat, which in turn may be on top of the substrate. Such towels may solve the problem of sweat making the mat slippery. Such towels may also mitigate against odor retention in the mat and offensive odor outgassing from the mats reaching the user. Such towels may also generally be easily cleaned and machine washable. Such towels also may protect the mat from wear and tear. Such towels may also provide a fabric or fabric like feel to the user.

However, use of such towels has created at least one new and major problem, that of slippage between the towel and the mat. In practice, such towels easily become dissociated from an ideal orientation on top of the mat, generally requiring the user to temporarily cease exercising to reorient the towel in its ideal location on top of the mat. For example, such preexisting towels easily become wrinkled and/or folded in undesirable ways when the user attempts to use the towel that is placed on top of the mat. See e.g., FIG. 1A and FIG. 1B which may depict such problems. FIG. 1A may depict user 1900 performing yoga on top of prior art yoga mat towel 1500, wherein prior art yoga mat towel 1500 may be at least partly on top of mat 1700. Because prior art yoga mat towel 1500 has no or poorly functioning means for associating with mat 1700, as user 1900 moves on top of prior art yoga mat towel 1500 wrinkles and folds 1501 develop. Such wrinkles and folds 1501 may be undesirable for user 1900. Such wrinkles and folds 1501 may pose safety problems, e.g., creating potential for tripping. Such wrinkles and folds 1501 may be uncomfortable to user 1900. Such wrinkles and folds 1501 may cause interruption to user 1900 who may need to rearrange prior art yoga mat towel 1500 to reduce wrinkles and folds 1501. FIG. 1B may also illustrate similar wrinkles and folds 1501 problems with prior art yoga mat towel 1500.

Some prior art towels have attempted to solve this slippage, dissociating, wrinkling, and/or folding problem by adding a plurality of tactile bumps to a bottom of such towels, such as silicone bumps. However, this solution has created another problem, in that the user may be able to feel these bumps as the user moves and uses such towels while on top of such towels and that feeling of such bumps may be undesirable.

There then is a need in the art for a towel or a towel like structure, such as a cover for exercise mats which may perform the towel's normal functions (e.g., moisture absorbing and fabric feel), yet also remain in place during use, and that does not detract from the mat's traction with the substrate nor provide a bumpy surface to work upon.

It is to these ends that the present invention has been developed.

### BRIEF SUMMARY OF THE INVENTION

To minimize the limitations in the prior art, and to minimize other limitations that will be apparent upon reading and understanding the present specification, the present invention may describe a cover, such as a towel or a towel like structure, for at least partially covering an article, such as a mat. In some embodiments, the article may be an exercise mat, such a yoga mat and/or a Pilates mat.

In some embodiments, the cover may substantially cover an external surface of the article. In some embodiments, the cover may comprise a shape (e.g., 2D shape when viewed from above and the cover is laying flat upon some surface) that may generally—but not necessarily completely—match a complimentary shape of the article. For example, and without limiting the scope of the present invention, in some embodiments, wherein the article may be a rectangular shape (as viewed from above), the cover may also be a rectangular shape or may be shaped as an octagon, but in either case, the cover shape may be larger than the article shape.

In some embodiments, the cover may comprise a first surface, a second surface, and an article attachment means. When the cover may be in use with the article, a portion of the first surface may be in removable physical contact with a user. For example, and without limiting the scope of the present invention, the user may be standing or lying down upon the first surface. The second surface may be disposed opposite of the first surface. In some embodiments, the second surface may be separated from the first surface by a thickness. When the cover may be in use with the article, then the second surface may be in substantial physical contact with at least some portion of the article. The article attachment means may be configured to removably attach at least one portion of the article to the cover. In some embodiments, the article attachment means may function by removably trapping either an article terminal end or at least one article corner. The article attachment means may function by forming a hollow tube (e.g., a cavity or a bridge), wherein either the article terminal end or the at least one article corner may removably pass through the hollow tube (or below the bridge) and/or be removably held within the cavity. Such a configuration may then prevent or minimize slippage between the cover and the article.

The cover may be a towel or a towel like structure in some exemplary embodiments, e.g., a yoga towel and/or a Pilates towel. In some embodiments, the cover may substantially cover at least one external surface of the article (e.g. a top external surface). In some embodiments, the cover may provide the user with a soft yet non slippery interface, such that direct interaction (e.g., direct physical contact) with the article by the user may be minimized during exercise (such as yoga, Pilates, stretching, and/or floor exercises).

It is an objective of the present invention to provide a cover for substantially covering an upper surface of an exercise mat in manner that minimizes slippage between the mat and the cover.

It is another objective of the present invention to provide a cover which may be soft.

It is another objective of the present invention to provide a cover which may be flexible.

It is another objective of the present invention to provide a cover which may be moisture absorbing.

It is another objective of the present invention to provide a cover which may be nonslippery when wet.

It is another objective of the present invention to provide a cover which may protect the article from wear and tear.

It is another objective of the present invention to provide a cover which may be easily washable, including machine washable.

It is another objective of the present invention to provide a cover with an article attachment means, wherein the article attachment means does not result in excessive bumpiness to the user.

It is yet another objective of the present invention to provide a cover which when in removable contact with the article, minimally detracts from the article's traction with the substrate.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A (prior art) may depict wrinkle and/or fold problems of a prior art yoga mat towel, when in use by a user, from a top perspective front view.

FIG. 1B (prior art) may depict wrinkle and/or fold problems of the prior art yoga mat towel, when in use by the user, from a top perspective back view.

FIG. 2A may depict an exemplary embodiment a cover (e.g. a towel); wherein the user may be exercising on top of this cover, wherein this cover may partially cover an article (e.g. an exercise mat), all depicted from a top perspective view.

FIG. 2B may depict the cover and the mat from FIG. 2A; however, in FIG. 2B the user may be sitting on top of the cover, that may be on top of the mat, and folding a portion of a union of the cover and the mat back towards the user, exposing portions of an underside of the mat and exposing portions of two article attachment means of the cover, all viewed from a top perspective view.

FIG. 2C may depict the cover and the mat from FIG. 2A; however, in FIG. 2C the user may be exercising, partially on top of the cover and partially on top of a portion of the mat, wherein in FIG. 2C, a longitudinal portion of the union of the cover and the mat may be folded over towards the user, exposing some of the underside of the mat, and at least some of one article attachments means of the cover, all viewed from a top perspective view.

FIG. 3A may depict the exemplary cover embodiment of FIG. 2A, but without depicting the user and shown from a top perspective view.

FIG. 3B may depict the cover and the article of FIG. 2A, shown side by side, not in physical contact, and shown from a top view.

FIG. 4A may depict the exemplary cover embodiment of FIG. 2A, but without depicting the article and shown from a top perspective view.

FIG. 4B may depict the exemplary embodiment of the cover from FIG. 2A from a top view.

FIG. 4C may depict the exemplary embodiment of the cover from FIG. 2A from a bottom view.

FIG. 4D may depict the exemplary embodiment of the cover from FIG. 2A from a longitudinal side view.

FIG. 4E may depict the exemplary embodiment of the cover from FIG. 2A from a transverse width end side view.

FIG. 5 may depict a close up view of the cover of FIG. 2A from a similar bottom view as in FIG. 4C, but in FIG. 5 depicting only one end of the cover, showing how two article attachment means of the cover may removably trap (engage) corners of the article.

FIG. 6 may depict an alternative embodiment of a cover which may employ a different segment-planar-shape, a hexagon, than disclosed in FIG. 2A through FIG. 5, shown from a bottom perspective view.

FIG. 7 may depict an alternative embodiment of a cover which may employ a different segment-planar-shape, a triangle, than disclosed in FIG. 2A through FIG. 6, shown from a bottom perspective view.

FIG. 8 may depict an alternative planar shape for a cover as compared against the covers of FIG. 2A through FIG. 6, shown from a bottom perspective view.

FIG. 9 may depict a cover embodiment that may comprise an anti-slip means, wherein the cover may be removably attached to the mat, shown from a bottom perspective view.

FIG. 10 may depict two alternative article attachment means embodiments, one operating at each of two corners of the article being removably held by a cover, shown from a bottom perspective view.

FIG. 11 may depict a close up view of DETAIL 11, wherein DETAIL 11 may be shown in FIG. 5 and in FIG. 7 through FIG. 10.

FIG. 12A through FIG. 12I may depict various different geometric 2D shapes, as viewed from above, for a segment of material; wherein each of these segments of materials may be an external component of a given article attachment means.

### REFERENCE NUMERAL SCHEDULE

200 cover 200
   201 first surface 201
   303 longitudinal length 303
   304 transverse width 304
   401 cover thickness 401 (towel thickness 401)
   402 second surface 402
   403 overall thickness 403
   411 first edge 411
   412 second edge 412
   413 third edge 413
   414 fourth edge 414
   415 fifth edge 415
   416 sixth edge 416
   417 seventh edge 417
   418 eighth edge 418
   421 first linear dimension 421
   422 second linear dimension 422
   423 third linear dimension 423
   501 segment of material 501
   502 exterior surface 502
   511 first trap-side 511
   512 second trap-side 512
   513 third trap-side 513
   514 fourth trap-side 514
   515 larger opening 515
   516 smaller opening 516
   550 means for attaching 550
600 cover 600
   601 symmetrical irregular hexagon 601
   611 first hex-side 611
   612 second hex-side 612
   613 third hex-side 613
   614 fourth hex-side 614
   615 fifth hex-side 615
   616 sixth hex-side 616
   617 large opening 617
   618 smaller openings 618
700 cover 700
   701 triangle segment of material 701
   704 single opening 704
   711 first tri-side 711
   712 second tri-side 712
   713 third tri-side 713
800 cover 800
900 cover 900
   901 anti-slip means 901
1000 cover 1000
   1001 segment of material 1001
   1003 first longer slit 1003
   1005 second shorter slit 1005
   1007 triangle opening 1007
1101 region of overlap 1101
1201b segment of material 1201b
1201c segment of material 1201c
1201d segment of material 1201d
1201e segment of material 1201e
1201f segment of material 1201f
1201g segment of material 1201g
1201h segment of material 1201h
1201i segment of material 1201i
1213b third trap-side 1213b
1213d third trap-side 1213d
1211c first trap-side 1211c
1211e first trap-side 1211e
1500 prior art yoga mat towel 1500
   1501 wrinkle and/or fold 1501
1700 article 1700
   1701 article terminal end 1701
   1702 article corner 1702
1900 user 1900

### DETAILED DESCRIPTION OF THE INVENTION

A cover, such as a towel or towel like structure, for at least partially covering an article, such as a mat, is described and disclosed. In some embodiments, the cover may be configured to substantially cover an external surface of the article. In some embodiments, the cover may comprise a shape that may generally match a complimentary shape of the article. For example, and without limiting the scope of the present invention, in some embodiments, wherein the article may be a rectangular shape, the cover may also be a rectangular shape or may be shaped as an octagon, but in either case, the cover shape may be larger than the article shape. In some embodiments, a cover larger than the article may mean that the cover comprises a longer longitudinal length and/or a wider transverse width. In some embodiments, this cover shape may be a planar shape of the cover.

In some embodiments, the cover may comprise a first surface (i.e., an upper surface), a second surface (i.e., a bottom surface), and an article attachment means. In some embodiments, the cover may comprise at least one edge that may circumscribe the first surface and the second surface, substantially forming the planar shape. When the cover may be in use with the article, a portion of the first surface may be in removable physical contact with a user. The second surface may be disposed opposite of first surface. In some embodiments, the second surface may be separated from the first surface by a thickness (i.e., a cover thickness). When the cover may be in use with the article, then a majority of the second surface may be in substantial physical contact with at least some portion of the article. The article attachment means may be configured to removably attach at least one portion of the article to the cover. The article attachment means may comprise at least one segment of material that may be removably attached over a portion of the second surface to at least one edge of the cover forming a hollow tube or a cavity. In some embodiments, the article attachment means may function by removably trapping either an article terminal end (or pair of adjoining article corners) or at least one article corner by either the article terminal end (or pair of adjoining article corners) or the at least one article corner being removably passed through the hollow tube and/or being removably held within the cavity. In some embodiments, this hollow tube may be structurally a bridge, wherein a spanning portion of such a bridge may be the at least one segment of material that covers the portion of the second surface.

In some embodiments, the article may be an exercise mat, such a yoga mat and/or a Pilates mat. In some embodiments, the article may be a personal exercise mat, such a yoga mat and/or a Pilates mat. The cover may be a towel in some exemplary embodiments, e.g., a yoga towel and/or a Pilates towel. In some embodiments, the cover may substantially cover at least one external surface of the article (e.g., a top external surface). In some embodiments, the cover may provide the user with a soft yet non slippery interface, such that direct interaction (e.g., direct physical contact) with the article by the user may be minimized during exercise (such as yoga and/or Pilates) and/or stretching.

Minimizing such direct physical contact may be beneficial to the user to mitigate against slipperiness of the article when the article may become wet, e.g., from sweat. Minimizing such direct physical contact may be beneficial to the user to mitigate against wear and tear of the article, i.e., the cover may act to protect the article. Minimizing such direct physical contact may be beneficial to the user to mitigate against offending smells emanating from the article from reaching the user, as some articles may be constructed of various plastics which may outgas various smells that the user may find offending.

In some embodiments, the article may be generally a planar and a rectangular member with four corners, i.e., two pairs of adjoining corners opposing each other. In some embodiments, the article may be flexible, compressible, and/or elastic. In some embodiments, the article may comprise at least one article corner. In some embodiments, dimensions of the cover may be sized such that the cover substantially covers at least one external surface of the article.

For example, and without limiting the scope of the present invention, when the article may comprise a yoga mat, many yoga mats may be available in a variety of standard sizes, such as 68 inches in length by 24 inches in width. 72 inch long yoga mats may also be available. Some yoga mats may have lengths varying from 72 inches to and including 68 inches. Yoga mats may be available in other lengths. Some yoga mats may have widths varying from 30 inches to and including 24 inches. Some yoga mats may have a width of 26 inches. Yoga mats may be available in other widths. 30 inch wide yoga mats may be commonly available in either the 68 inch or the 72 inch variety. Other yoga mat dimensions may be available. Regardless, of yoga mat dimensions, the cover (e.g. as a yoga towel) may be sized to substantially cover an external surface of the particularly sized yoga mat.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

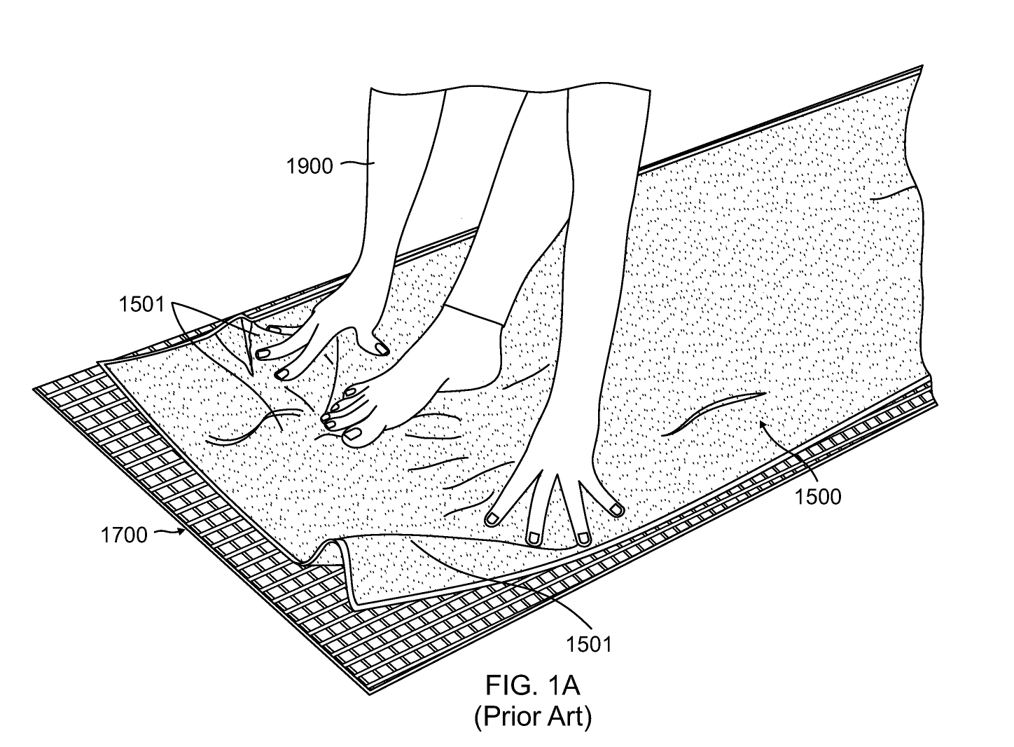

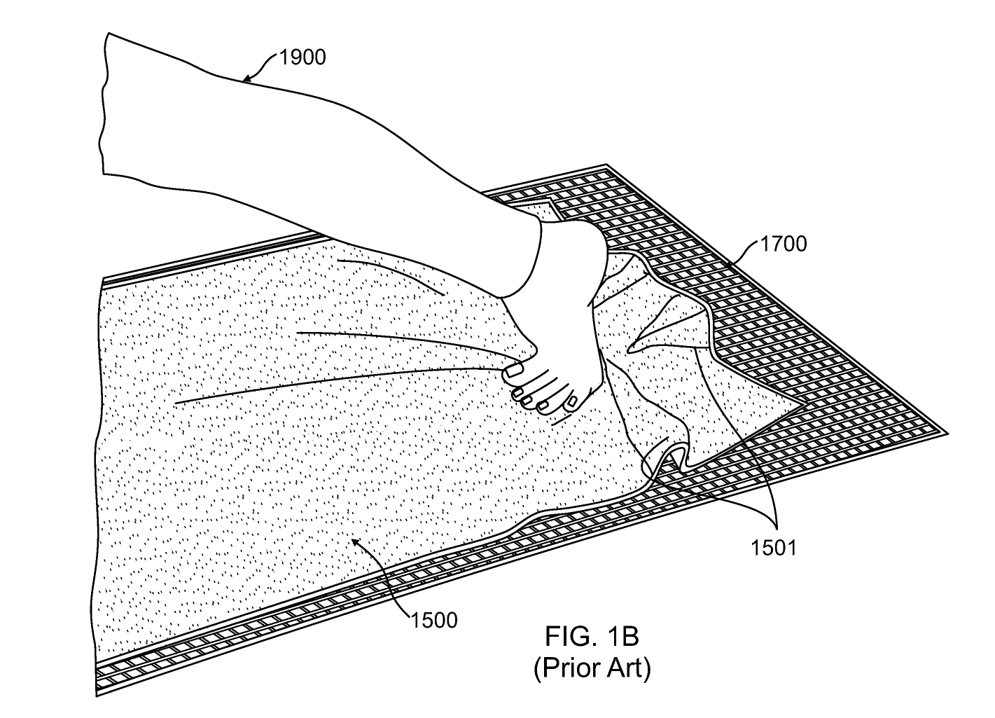

The FIG. 1 series of figures may comprise FIG. 1A and FIG. 1B, both of which were discussed above in the Background of the Invention section pertaining to problems of prior art yoga mat towel 1500.

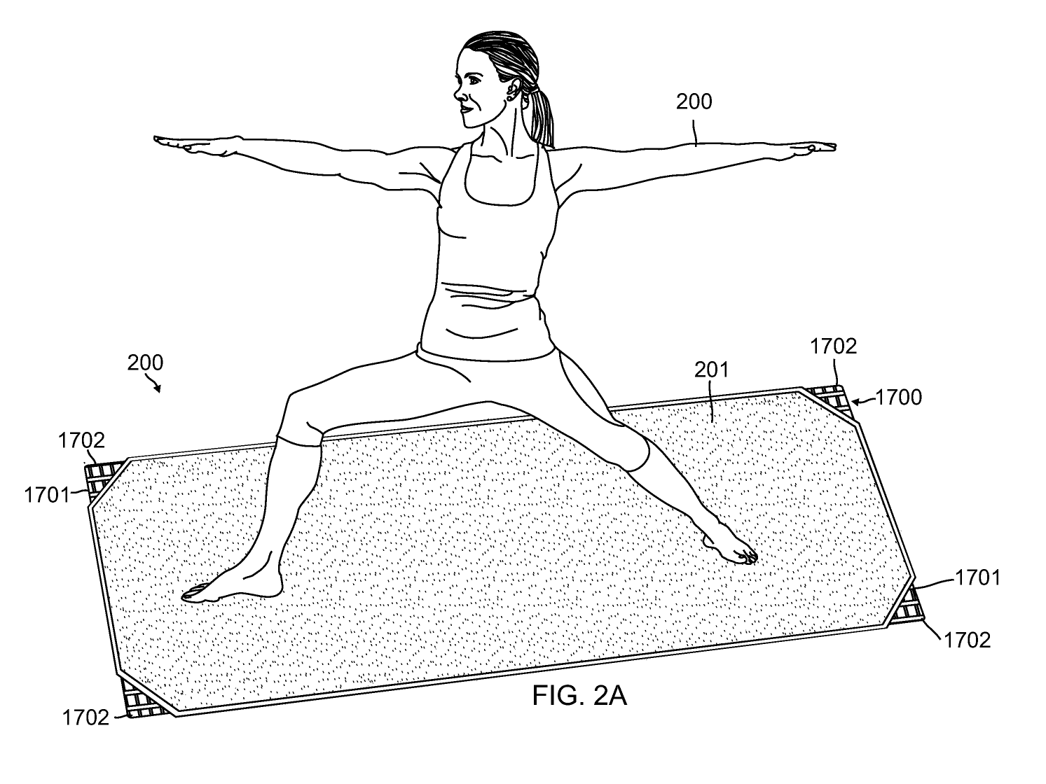

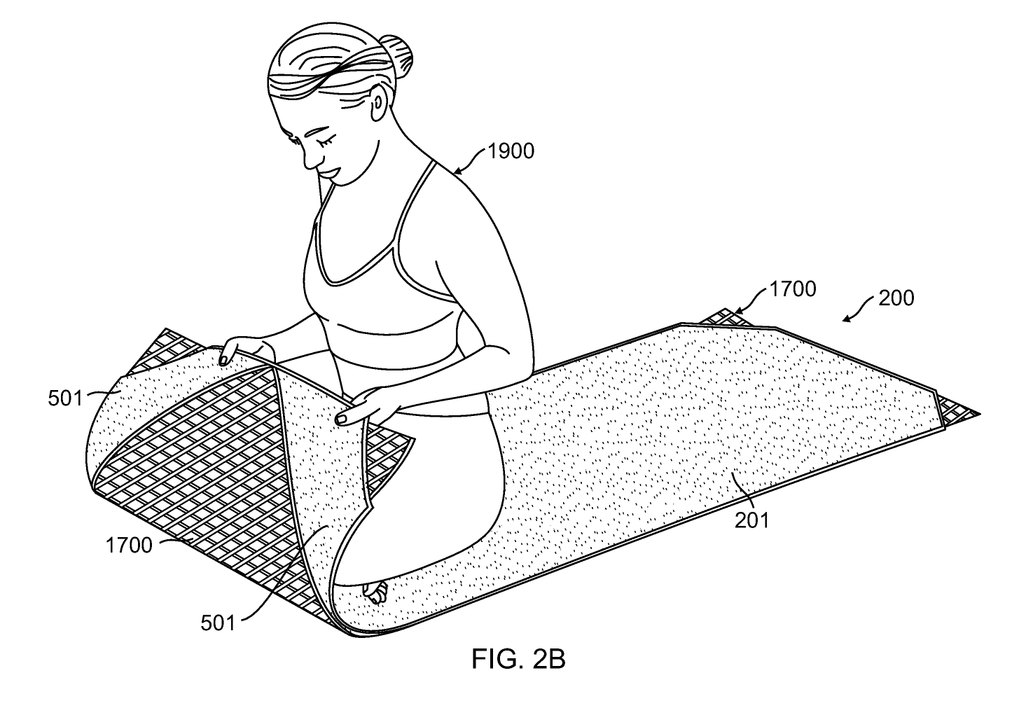

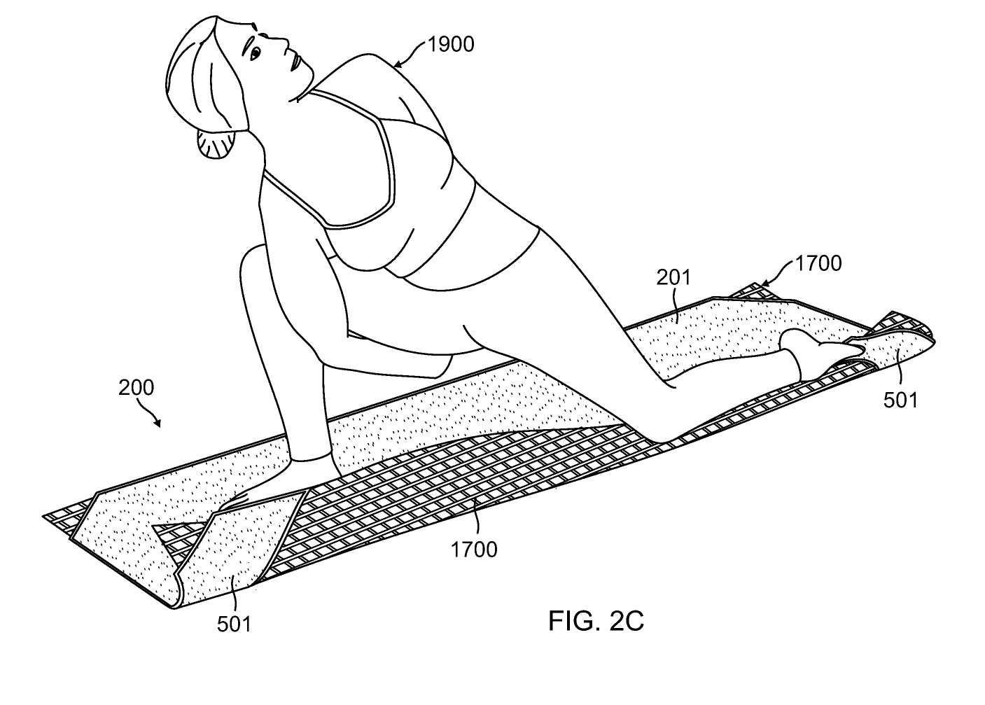

A FIG. 2 series of may comprise FIG. 2A through FIG. 2C. The FIG. 2 series of figures may depict some user 1900 using and/or interacting with cover 200 and with article 1700. This FIG. 2 series of figures may depict some communicative and size relationships between cover 200 and article 1700; and between user 1900 and cover 200. For example, and without limiting the scope of the present invention, in some embodiments, cover 200 may be both longer and wider than a corresponding article 1700.

FIG. 2A may depict an exemplary embodiment a cover 200 (e.g., a towel 200); wherein user 1900 may be exercising on top of this cover 200, wherein this cover 200 may partially cover an article 1700 (e.g., an exercise mat 1700). Cover 200 may cover all of article 1700 (e.g., an exercise mat 1700) except for corners 1702. FIG. 2A may be depicted from a top perspective view.

FIG. 2B may depict cover 200 and article 1700 from FIG. 2A; however, in FIG. 2B user 1900 may be sitting on top of cover 200, that may be on top of the article 1700, and user 1900 may be folding a portion of a removable union of cover 200 and article 1700 back towards the user 1900. This folding over may expose portions of an underside of article 1700 and may expose portions of two article attachment means of the cover 200, all viewed from a top perspective view. Note, FIG. 2B may not illustrate a proper exercise use of cover 200 with article 1700; but may illustrate how cover 200 may be removably attached to at least some portion of article 1700. FIG. 2B may illustrate communicative and size relationships as between cover 200 and article 1700 and as between user 1900 and cover 200.

FIG. 2C may depict cover 200 and article 1700 from FIG. 2A; however, in FIG. 2C user 1900 may be exercising, partially on top of cover 200 and partially on top of a portion of the article 1700, wherein in FIG. 2C, a longitudinal portion of the removable union of cover 200 and article 1700 may be folded over towards user 1900, exposing some of the underside of article 1700, and exposing at least some of one article attachments means of cover 200, all viewed from a top perspective view. Note, FIG. 2C may not illustrate a proper exercise use of cover 200 with article 1700; but may illustrate how cover 200 may be removably attached to at least some portion of article 1700. FIG. 2C may illustrate communicative and size relationships as between cover 200 and article 1700 and as between user 1900 and cover 200.

As shown in FIG. 2A, FIG. 2B, and FIG. 2C, in some embodiments, cover 200 may comprise first surface 201 (which may be a top or an upper surface). In some embodiments, when cover 200 may be in use with article 1700, at least some portions of first surface 201 may be in removable physical contact with user 1900. See e.g., FIG. 2A, FIG. 2B, and FIG. 2C. In some embodiments, first surface 201 may be top or upper exterior surfaces of cover 200.

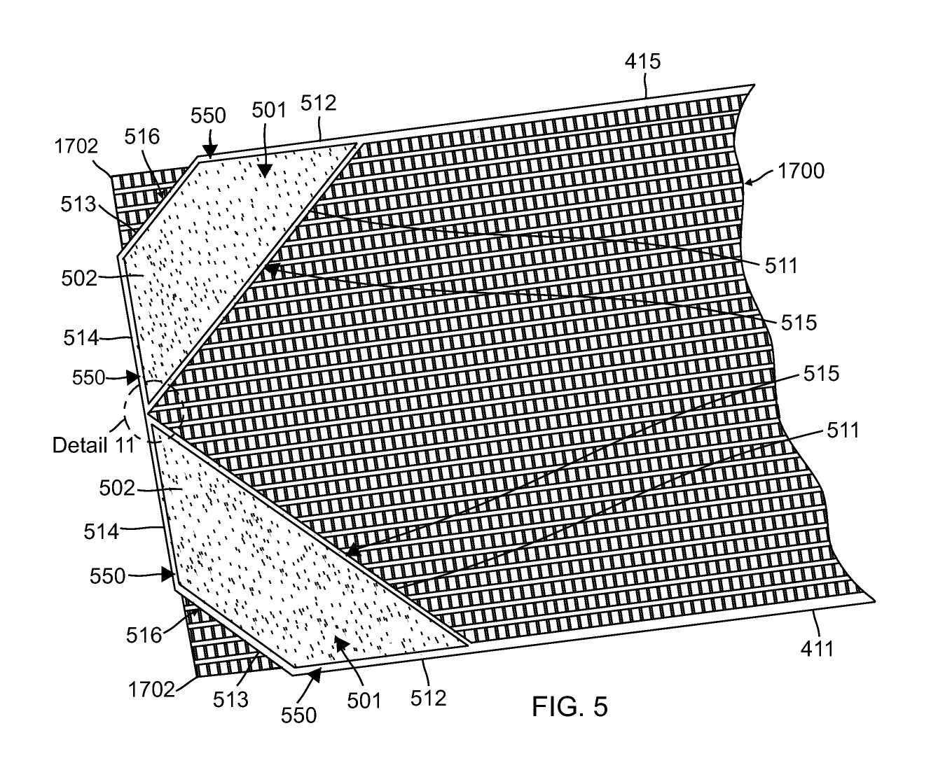

As shown in FIG. 2B and FIG. 2C, in some embodiments, cover 200 may comprise the article attachment means. The article attachment means may comprise at least one segment of material 501. The article attachment means and at least one segment of material 501 may be discussed in further detail below in the FIG. 5 discussion.

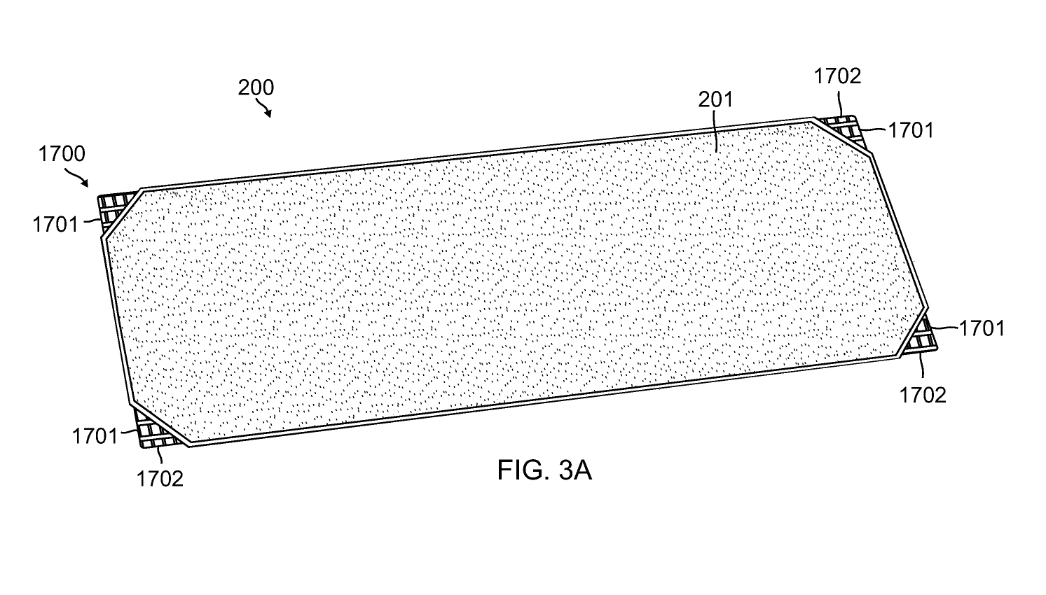

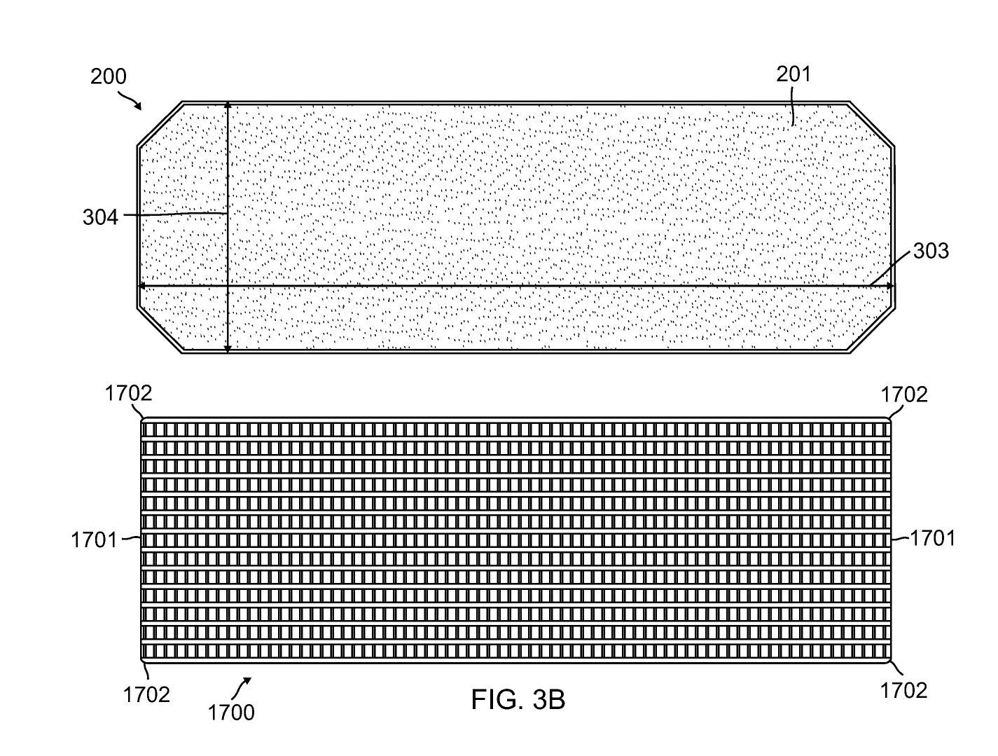

A FIG. 3 series of figures may comprise FIG. 3A and FIG. 3B. FIG. 3A may depict exemplary cover 200 embodiment of FIG. 2A, but without depicting user 1900 and shown from a top perspective view. FIG. 3B may depict cover 200 and article 1700 of FIG. 2A, shown side by side, not in physical contact (nor in communication), and shown from a top view.

As noted above, in some embodiments, article 1700 may be an exercise mat, such a yoga mat and/or a Pilates mat. As noted above, in some embodiments, article 1700 may be a personal exercise mat, such a yoga mat and/or a Pilates mat. Cover 200 may be a towel 200 in some exemplary embodiments. In some embodiments, cover 200 may substantially cover at least one external surface of article 1700 (e.g., a top external surface). In some embodiments, cover 200 may provide user 1900 with a soft yet non slippery interface, such that user 1900 direct interaction (e.g., direct physical contact) with article 1700 may be minimized during exercise (such as yoga and/or Pilates) and/or during stretching.

Minimizing such direct physical contact may be beneficial to user 1900 to mitigate against slipperiness of article 1700 when article 1700 may become wet, e.g., from user 1900 sweat. Minimizing such direct physical contact may be beneficial to user 1900 to mitigate against wear and tear of article 1700. Minimizing such direct physical contact may be beneficial to user 1900 to mitigate against offending smells emanating from article 1700 from reaching user 1900.

In some embodiments, article 1700 may be generally a planar and rectangular member. In some embodiments, article 1700 may be flexible, compressible, and/or elastic. In some embodiments, article 1700 may comprise at least one article corner 1702. As depicted in FIG. 3A and FIG. 3B, article 1700 may comprise four distinct article corners 1702. These four corners 1702 may be arranged as two pairs of adjoining corners 1702 opposing each other.

In some embodiments, cover 200 may comprise at least one edge that may circumscribe first surface 201 and a second surface 402 substantially forming a planar shape. In some embodiments, this planar shape of cover 200 may be an octagon, such as a planar octagon, when viewed from above and cover 200 may be laying flat upon some surface or substrate. See e.g., FIG. 3B. As noted, in some embodiments, cover 200 may comprise first surface 201.

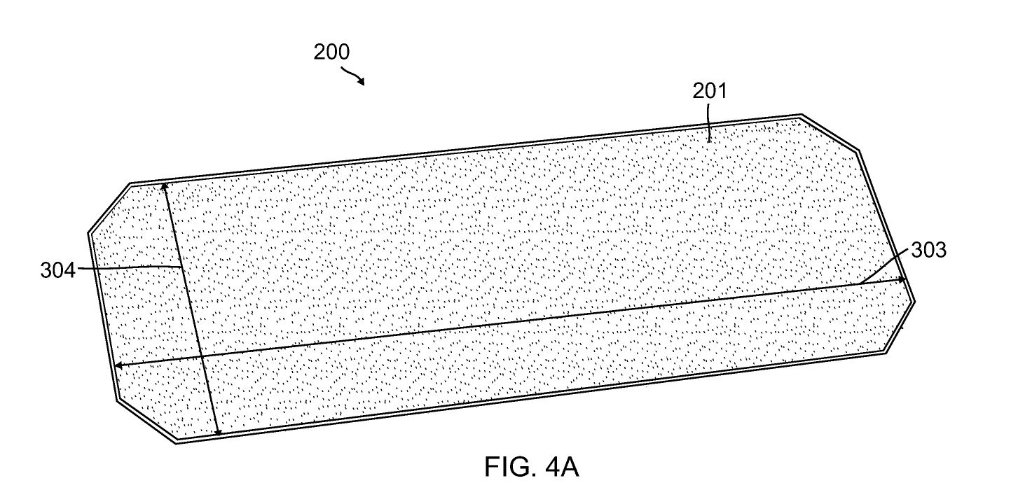

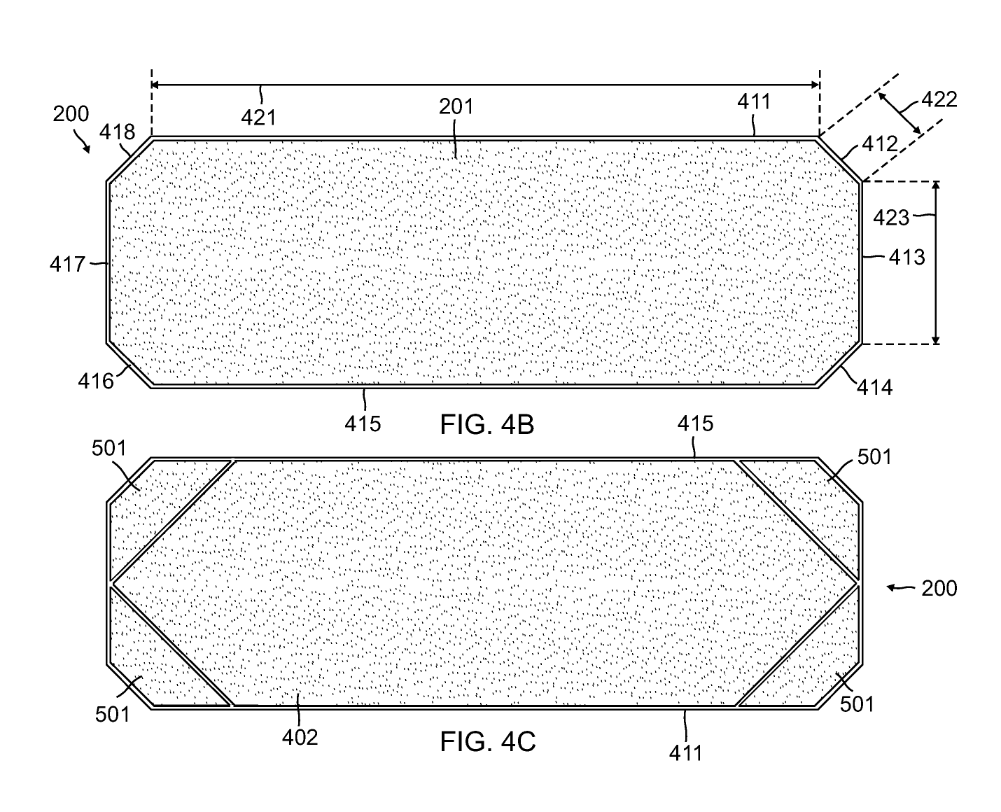

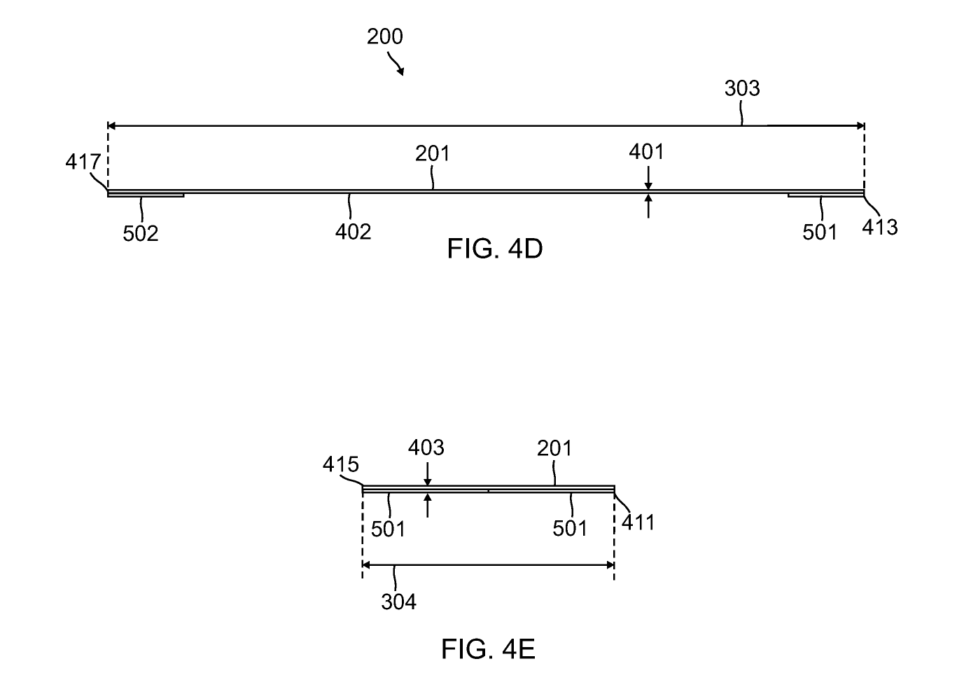

In some embodiments, cover 200 may comprise a longitudinal length 303. See FIG. 3B. In some embodiments, longitudinal length 303 may run a longitudinal length of cover 200. In some embodiments, longitudinal length 303 may be disposed between a third edge 413 and a seventh edge 417. See e.g., FIG. 3B and FIG. 4A for longitudinal length 303 and see FIG. 4B for third edge 413 and seventh edge 417.

In some embodiments, cover 200 may comprise a transverse width 304. In some embodiments, transverse width 304 may run a transverse width of cover 200. See FIG. 3B. In some embodiments, transverse width 304 may be disposed between a first edge 411 and a fifth edge 415. See e.g., FIG. 3B and FIG. 4A for transverse width 304 and see FIG. 4B for first edge 411 and fifth edge 415.

In some embodiments of cover 200, longitudinal length 303 may be greater than transverse width 304. In FIG. 3B, longitudinal length 303 may be substantially perpendicular to transverse width 304. In some embodiments, longitudinal length 303 may be less than, the same, or greater than a corresponding length of article 1700. For example, some article 1700 may have lengths from 68 inches to 72 inches. In some embodiments and regardless of article 1700 length, longitudinal length 303 may be up to one inch shorter, the same length as article 1700, or up to one inch longer than article 1700. In some embodiments, transverse width 304 may be less than, the same, or greater than a corresponding width of article 1700. For example, some article 1700 may have transverse widths from 24 inches to 30 inches. In some embodiments and regardless of article 1700 transverse width, transverse width 304 may be up to one inch shorter, the same transverse width as article 1700, or up to one inch wider than article 1700. In some exemplary embodiments, the given cover embodiment (e.g., cover 200) may be about 0.25 inch longer (plus or minus 0.10 of an inch) than a given article 1700 in all directions.

A FIG. 4 series of figures may depict an overall structure and geometry of cover 200. The FIG. 4 series of figures may comprise FIG. 4A through FIG. 4E. FIG. 4A may depict exemplary cover 200 embodiment of FIG. 2A, but without depicting article 1700 and shown from a top perspective view. FIG. 4B may depict the exemplary embodiment of cover 200 from FIG. 2A from a top view. FIG. 4C may depict the exemplary embodiment of cover 200 from FIG. 2A from a bottom view. FIG. 4D may depict the exemplary embodiment of cover 200 from FIG. 2A from a longitudinal side view. FIG. 4E may depict the exemplary embodiment of cover 200 from FIG. 2A from a transverse width end side view.

In some embodiments, the planar shape of cover 200 may be substantially shaped as a planar octagon, if cover was laying flat upon a substrate and viewed from above. See e.g., FIG. 4A, FIG. 4B, and FIG. 4C. In some embodiments, this octagon may be a substantially planar (i.e. flat) octagon, as in a planar octagon. In some embodiments, such a cover 200 may be flexible (see e.g., FIG. 2B and FIG. 2C).

Continuing discussing the FIG. 4 series of figures, in some embodiments, cover 200 may comprise at least one edge. This at least one edge may circumscribe first surface 201 and second surface 402 forming the planar shape of cover 200, including the planar octagon shape in some embodiments. In some embodiments, this at least one edge may comprise eight edges forming the planar octagon shape of cover 200. In some embodiments, these eight edges may comprise: first edge 411, a second edge 412, third edge 413, a fourth edge 414, fifth edge 415, a sixth edge 416, seventh edge 417, and an eighth edge 418. In some embodiments, first edge 411 may connect to second edge 412; where second edge 412 may then connect to third edge 413; where third edge 413 may then connect to fourth edge 414; where fourth edge may then connect to fifth edge 415; where fifth edge 415 may then connect to sixth edge 416; where sixth edge 416 may then connect to seventh edge 417; where seventh edge 417 may then connect to eighth edge 418; and finally where eighth edge 418 may connect to first edge 411. See FIG. 4B. In some embodiments, first edge 411 may be substantially parallel with fifth edge 415. In some embodiments, second edge 412 may be substantially parallel with sixth edge 416. In some embodiments, third edge 413 may be substantially parallel with seventh edge 417. In some embodiments, fourth edge 414 may be substantially parallel with eighth edge 418.

In some embodiments, each pair of substantially parallel edges may have a substantially same linear dimension. For example, and without limiting the scope of the present invention, first edge 411 and fifth edge 415 may both substantially include a first linear dimension 421. For example, and without limiting the scope of the present invention, second edge 412, sixth edge 416, fourth edge 414, and eighth edge 418 may all substantially include a same second linear dimension 422. For example, and without limiting the scope of the present invention, third edge 413 and seventh edge 417 may both substantially include a same third linear dimension 423. In some embodiments, first linear dimension 421 may be greater than the third linear dimension 423. In some embodiments, third linear dimension 423 may be greater than second linear dimension 422.

Although not depicted in the FIG. 2 series of figures nor the FIG. 3 series of figures, cover 200 may comprise second surface 402 (see e.g., FIG. 4C). In some embodiments, second surface 402 may be disposed opposite of first surface 201. In some embodiments, second surface 402 and first surface 201 may be separated from each other by a cover thickness 401 (see e.g., FIG. 4D). In some embodiments, when cover 200 may be in use with article 1700, then a majority of second surface 402 may be in substantial physical contact with at least some external portions of article 1700. In some embodiments, first surface 201 may be a top or an upper surface of cover 200. In some embodiments, second surface 402 may be a bottom surface of cover 200.

Various cover embodiments may comprise various article attachment means. The article attachment means may be configured to removably attach at least one portion of article 1700 to cover 200. In some embodiments, the article attachment means may function by removably trapping either an article terminal end 1701 (which may comprise a pair of adjoining corners 1702) or at least one article corner 1702. In some embodiments, the article attachment means may function by forming a hollow tube, a bridge, and/or a cavity, wherein either article terminal end 1701 or at least one article corner 1702 may removably pass through the hollow tube, removably under the bridge, and/or be removably held within the cavity. In some cover 200 embodiments, the article attachment means may comprise at least one segment of material 501. See FIG. 4C. In some embodiments, each segment of material 501 may comprise exterior surface 502. Exterior surface 502 may be an exterior surface of a given segment of material. Exterior surface 502 may face in direction common to that of second surface 402. See FIG. 4D and FIG. 5. Attachment of at least one segment of material 501 to cover 200 may form the hollow tube and/or the bridge. Attachment of other types of segments of material to the cover may form the cavity. The article attachment means and segments of material are discussed further in FIG. 5 through FIG. 12, with FIG. 5 pertaining to cover 200.

In some embodiments, cover 200 may comprise an overall thickness 403. See FIG. 4E. In some embodiments, overall thickness 403 may be a thickness that is disposed between first surface 201 and exterior surface 502 of segment of material 501. In some embodiments, at the location where segment of material 501 may be located on cover 200, then an overall thickness 403 may be about twice cover thickness 401. See e.g., FIG. 4E and FIG. 4D.

Note in some embodiments, first surface 201, second surface 402, and/or exterior surface 502 may comprise regions for graphic display, including regions for displaying various designs, colors, patterns, logos, trademarks, screen prints, thermal prints, and/or the like. In some embodiments, such regions may substantially comprise the entirety of first surface 201, the entirety of second surface 402, and/or the entirety of exterior surface 502; or less than such entire surfaces.

In some embodiments, first edge 411, second edge 412, third edge 413, fourth edge 414, fifth edge 415, sixth edge 416, seventh edge 417, and eighth edge 418 may circumscribe and bound this planar octagonal shape depicted in the FIG. 4 series of figures. See e.g., FIG. 4B and FIG. 4C. In some embodiments, first edge 411, second edge 412, third edge 413, fourth edge 414, fifth edge 415, sixth edge 416, seventh edge 417, and eighth edge 418 may circumscribe and bound first surface 201 and second surface 402. See e.g., FIG. 4B and FIG. 4C.

In some embodiments, first surface 201, second surface 402, and cover thickness 401 may all be integral with respect to each other as a single article of manufacture. In some embodiments, first surface 201 and second surface 402 may be mirror images of each other in terms of a two dimensional shape of first surface 201 and second surface 402, as viewed from above or below, if cover 200 may be laying flat upon a substrate or a surface. In some embodiments, the attachment means may be located proximate to portions of second surface 402 or substantially facing portions of second surface 402, but not necessarily attached to second surface 402. In some embodiments, the attachment means may be located on portions of the at least one edge, such as a hem(s) of the at least one edge.

In some exemplary embodiments, each edge of cover 200, including the at least one edge (e.g., first edge 411 through and including eighth edge 418 and/or segment of material edges in some embodiments), may be configured to prevent or mitigate against edge fraying or edge unraveling. This may be accomplished by a hem and/or a hem means at or proximate to each such edge. In this context, in some embodiments, proximate may be a half inch or less. In some embodiments, such hems may comprise a reinforcing strip within the hem and the hem may be sewn over such a reinforcing strip. In some embodiments, such reinforcing strips may run substantially parallel with a given edge. In some embodiments, the hem may be formed by a hem means. In some embodiments, these hems may be denoted as means for attaching 550 in the accompanying figures, which may be illustrated as a white border in the figures. In some embodiments, these hems may have a uniform width in all locations such hems may be used in a given cover embodiment. In some exemplary embodiments, this uniform width may be about a 0.25 inch (plus or minus 0.10 of an inch). In some embodiments, the hem means may be selected from the group comprising one or more of: sewn stitching along at least a portion of a given edge (or proximate to the given edge); ultrasonic welding along at least a portion of a given edge (or proximate to the given edge); heat welding along at least a portion of a given edge (or proximate to the given edge); chemical adhesive use along at least a portion of a given edge (or proximate to the given edge); solvent bonding along at least a portion of a given edge (or proximate to the given edge); other mechanical fastener use (e.g., staples) along at least a portion of a given edge (or proximate to the given edge); and/or the like. In this context, in some embodiments, proximate may be a half inch or less. Some hem means may depend upon the materials of construction employed for cover 200. For example, heat based sealing and adhering means may be better suited for synthetic fabrics as opposed to natural fabrics. In some exemplary embodiments, this uniform width of the hems, represented by means for attaching 550, may be bounded by two parallel running lengths of sewn stitching to form the seam and/or hem.

In some embodiments, any of the following: first surface 201, second surface 402, cover thickness 401, the article attachment means, exterior surface 502, and/or overall thickness 403 may be substantially constructed of one or more of a flexible material and/or a soft material.

In some embodiments, any of the following: first surface 201, second surface 402, cover thickness 401, the article attachment means, exterior surface 502, and/or overall thickness 403 may be substantially constructed of a fabric material. The fabric material may be natural, synthetic, and/or a blend of natural and synthetic fabrics. Natural fabrics may comprise cottons, silks, linens, hemps, natural leathers, and/or natural rubbers (with or without latex). Synthetic fabrics may comprise various synthetic polymers. For example, and without limiting the scope of the present invention, some synthetic fabrics may comprise one or more of polyester, acrylic, nylon, rayon, acetate, spandex, lastex, Kevlar, and/or the like.

In some embodiments, any of the following: first surface 201, second surface 402, cover thickness 401, the article attachment means, exterior surface 502, and/or overall thickness 403 may be substantially constructed of a microfiber fabric material. Microfiber may be constructed of synthetic fibers, such as polyester, nylon, and/or polyamide fabric strands. Such individual strands may be 100 times or more finer than human hair. In some embodiments, the microfiber may a blend. For example and without limiting the scope of the present invention, in some embodiments, the microfiber blend may be of polyester and nylon or a blend of polyester and polyamide.

In some embodiments, any of the following: first surface 201, second surface 402, cover thickness 401, the article attachment means, exterior surface 502, and/or overall thickness 403 may be substantially constructed of a fabric material, wherein the fabric material may comprise one or more properties: flexibility, softness, moisture absorbing, mildew resistant, durable against machine washing, durable against user 1900 performing exercises while on first surface 201, and/or the like.

FIG. 5 may depict a close up view of cover 200 of FIG. 2A from a similar bottom view as in FIG. 4C, but in FIG. 5 depicting only one end of cover 200, showing how two article attachment means of cover 200 may removably trap (engage) corners 1702 of article 1700.

Note, in some embodiments, the article attachment means may be referred to a personal exercise mat attachment means; when article 1700 may be a personal exercise mat 1700.

In some embodiments, each article attachment means may comprise at least one segment of material 501 and a means for attaching 550 the at least one segment of material to cover 200. Means for attaching 550 may be depicted in the figures, including FIG. 5, as a white border at, near, or proximate to any edge (e.g., first edge 411 through and including eighth edge 418 and/or segment of material edges in some embodiments). In some embodiments, means for attaching 550 the at least one segment of material 501 to cover 200 may be selected from one or more of the group comprising: sewn stitching, ultrasonic welding, heat welding, chemical adhesive use, solvent bonding, other mechanical fasteners, and/or the like.

In some embodiments, segment of material 501 may be substantially constructed of a same material of construction as first surface 201, second surface 402, and/or cover thickness 401. In some embodiments, segment of material 501 may be substantially planar. In some embodiments, segment of material 501 may have a substantially same thickness as cover thickness 401. In some embodiments, at the location where segment of material 501 may be located on cover 200, then an overall thickness 403 may be twice the cover thickness 401. See e.g., FIG. 4E.

In some embodiments, segment of material 501 may comprise a segment-planar-shape; wherein this segment-planar-shape may be a two dimensional shape of segment of material 501 when segment of material 501 may be viewed from above and segment of material 501 may be laying flat. In some embodiments, this segment-planar-shape of segment of material 501 may be selected from: a regular polygon with or without rounded corners; an irregular polygon with or without rounded corners; a semi-circle; a semi-ellipse; an ellipse; a circle; a rectangle with or without rounded corners; a trapezoid with or without rounded corners; a hexagon with or without rounded corners; an elongate member; and/or combinations thereof. In some embodiments, at least one segment 501 may comprise at least two different ends, a first end and a second end. In some embodiments, the segment-planar-shape may comprise the at least two different ends, the first end and the second end. It may be the first end and the second end that may be attached to different regions of the at least one edge to form the hollow tube and/or the bridge.

Continuing discussing FIG. 5, in some embodiments, segment of material 501 may be substantially shaped as a trapezoid (e.g., an isosceles trapezoid or a scalene trapezoid). That is, in some embodiments, the segment-planar-shape may be a trapezoid, with or without rounded corners. In some embodiments, this trapezoid segment of material 501 may comprise a first trap-side 511, a second trap-side 512, a third trap-side 513, and a fourth trap-side 514. That is, in some embodiments, first trap-side 511, second trap-side 512, third trap-side 513, and fourth trap-side 514 may bound this trapezoid segment of material 501. In some embodiments, first trap-side 511 may share a vertex with second trap-side 512 on one end and share another vertex with fourth trap-side 514 on an opposing end. In some embodiments, second trap-side 512 may share a vertex with third trap-side 513 that opposes the vertex shared with first trap-side 511. In some embodiments, third trap-side 513 may share a vertex with fourth trap-side 514 that opposes the vertex shared with second trap-side 512. See FIG. 5.

In some embodiments, second trap-side 512 may be attached to either first edge 411 or fifth edge 415 by means for attaching 550. In some embodiments, second trap-side 512 may be the first end of segment of material 501. In some embodiments, fourth trap-side 514 may be attached to either third edge 413 or seventh edge 417 by means for attaching 550. Note, seventh edge 417 and third edge 413 are not explicitly called out in FIG. 5, as seventh edge 417 or third edge 413 would be directly under fourth trap-side 514 and joined together by means for attaching 550 (such as seam 550 or hem 550). In some embodiments, fourth trapside 514 may be the second end of the segment of material 501.

In some embodiments, attachment of the trapezoid shape of the segment-planar-shape for segment of material 501 to cover 200 may form the hollow tube and/or the bridge. In some embodiments, the hollow tube and/or the bridge may comprise two openings, a larger opening 515 and a smaller opening 516. In some embodiments, the hollow tube may be configured to accommodate removable passage of single article corner 1702 through larger opening 515 and through smaller opening 516. In some embodiments, first trap-side 511 and a portion of the second surface 402 covered by first trap-side 511 may form larger opening 515. In some embodiments, third trap-side 513 and a portion of second surface 402 covered by third trap-side 513 may form smaller opening 516. See e.g., FIG. 5.

In some embodiments, first trap-side 511 may be longer than the other three sides (512, 513, and 514). See e.g., FIG. 5. In some embodiments, first trap-side 511 may be longer than the other three sides and wherein first trap-side 511 may be substantially parallel with third trap-side 513, such that the trapezoid may be an isosceles trapezoid. See e.g., FIG. 5. In some embodiments, second trap-side 512 and fourth trap-side 514 may have substantially a same dimension. See e.g., FIG. 5. In some embodiments, second trap-side 512 and/or fourth trap-side 514 may have a dimension of one inch to sixteen inches, with a dimension of about seven inches (plus or minus 0.75 of an inch) being exemplary. In some embodiments, third trap-side 513 may have a dimension of about 7.5 inches (plus or minus 0.75 of an inch). In some embodiments, first trap-side 511 may have a dimension of about 18 inches (plus or minus six inches). In some embodiments, first trap-side 511 may be substantially parallel with third trap-side 513. In some embodiments, second trap-side 512 may be substantially perpendicular with fourth trap-side 514. In some embodiments, segment of material 501 may have a transverse width of about 5.125 inches (plus or minus 0.25 of an inch). In some embodiments, segment of material 501 may have a transverse width of about 5.375 inches (plus or minus 0.25 of an inch). See e.g., FIG. 5. In some embodiments, segment of material 501 may have a transverse width from one inch to six inches.

In some embodiments of cover 200, there may be one such trapezoid segment of material 501 for each corner 1702. For example, and without limiting the scope of the present invention, when article 1700 may be a rectangular yoga mat 1700 or Pilate mat 1700, cover 200 may comprise four separate trapezoid segments of material 501, wherein each may removably accept and hold a single corner 1702. FIG. 5 may depict two such segments of material 501 and FIG. 4C may depicted all four such segments of material 501.

Continuing discussing FIG. 5, in embodiments, where a single terminal end region of cover 200 may comprise two different trapezoid segments of material 501, each of the two first trap-sides 511 may terminate at a shared point or shared region on seventh edge 417 (see e.g., FIG. 5) or on third edge 413. See DETAIL 11 region in FIG. 5 for this shared region and/or shared point. In some embodiments, this shared point may be non-overlapping as depicted in FIG. 5. Whereas, in some embodiments, this shared region may be overlapping as indicated in a close up view of DETAIL 11 in FIG. 11 that depicts region of overlap 1101.

Continuing discussing FIG. 5, in some embodiments, second trap-side 512 and fourth trap-side 514 may have different dimensions such that the trapezoid may be a scalene trapezoid. While such scalene trapezoids may be not be depicted in the figures, such trapezoids are contemplated as within the scope of the invention and should fall within the skill of an ordinary practitioner of this art.

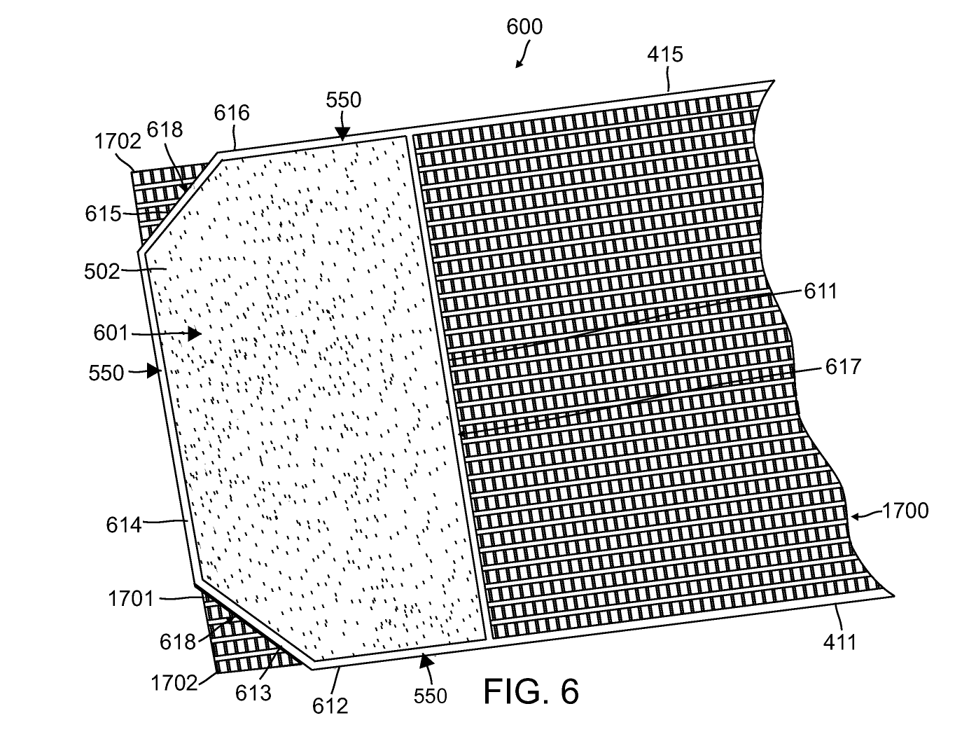

In some embodiments, segment of material 501 may be a strip disposed from first edge 411 to fifth edge 415, in which case larger opening 515 and smaller opening 516 may be substantially a same sized opening. This strip and/or band embodiment may not be explicitly depicted in the figures. In some embodiments, segment of material 501 may have a length substantially the same as transverse width 304 of cover 200. (See e.g., FIG. 6.) In some embodiments, segment of material 501 may be attached to cover 200 at first edge 411 and fifth edge 415 by means for attaching 550. That is, the first end of segment of material 501 may attach to first edge 411 and the second end of segment of material 501 may attach to fifth edge 415. In some embodiments, a portion of the strip may also be attached to cover 200 at third edge 413 or at seventh edge 417 by means for attaching 550. (See e.g., FIG. 6.) In some embodiments, an interior surface of the strip and a portion of second surface 402 that may be covered by this strip may form the hollow tube and/or the bridge with at least two openings. In some embodiments, the hollow tube may be configured to removably accept (accommodate) article terminal end 1701 of article 1700 such that article terminal end 1701 may removably pass through the hollow tube and/or removably under the bridge.

In some embodiments, the strip which may still have the segment-planar-shape may be substantially rectangular in shape with the length and a width, wherein the width is less than the length. Recall, the length of the strip may be substantially similar with transverse width 304 of cover 200. In some embodiments, the strip's segment-planar-shape may be shaped as a regular or an irregular polygon. In some embodiments, the strip may have a substantially uniform width and may follow a sinuous path from first edge 411 to fifth edge 415, that may or may not intersect with itself. These strip and/or band embodiments, aside from that shown in FIG. 6, may not be depicted in the figures.

FIG. 6 may depict an alternative embodiment of the cover, a cover 600, which may employ a different segment-planar-shape, a hexagon, than disclosed in FIG. 2A through FIG. 5, shown from a bottom perspective view. In some embodiments, cover 600 may differ from cover 200, in that the segment-planar-shape of segment of material 501 in cover 600 may be a strip that may be substantially shaped as a symmetrical irregular hexagon 601. See FIG. 6.

In some embodiments, symmetrical irregular hexagon 601 may comprise a first hex-side 611, a second hex-side 612, a third hex-side 613, a fourth hex-side 614, a fifth hex-side 615, and a sixth hex-side 616. In some embodiments, first hex-side 611 may be substantially parallel with fourth hex-side 614. In some embodiments, second hex-side 612 may be substantially parallel with sixth hex-side 616. In some embodiments, first hex-side 611 may be longer than the other five sides (612 through and including 616). In some embodiments, fourth hex-side 614 may be longer than the other five sides except first hex-side 611. In some embodiments, second hex-side 612 and sixth hex-side 616 may be substantially a same dimension and may be longer than each of third hex-side 613 and of fifth hex-side 615. In some embodiments, third hex-side 613 and fifth hex-side 615 may be substantially a similar dimension. In some embodiments, second hex-side 612 may be attached to either first edge 411 or fifth edge 415. In some embodiments, second hex-side 612 may be the second end of the segment of material. In some embodiments, sixth hex-side 616 may be attached to either fifth edge 415 or first edge 411 that second hex-side 612 may be not attached to. In some embodiments, sixth hex-side 616 may be the first end of the segment of material. In some embodiments, fourth hex-side 614 may be attached to seventh edge 417 or third edge 413. Note, seventh edge 417 and third edge 413 are not explicitly called out in FIG. 6, as seventh edge 417 or third edge 413 would be directly under fourth hex-side 614 and joined together by means for attaching 550 (such as seam 550). In some embodiments, attachment of symmetrical irregular hexagon 601 to cover 600 may form the hollow tube and/or the bridge. In some embodiments, the hollow tube and/or the bridge may have three openings, a large opening 617 along first hex-side 611 and smaller openings 618 at third hex-side 613 and at fifth hex-side 615, respectively. In some embodiments, two adjoining corners 1702 (i.e., closer corners 1702) of article 1700 each may removably fit through each of the two smaller openings 618. In some embodiments, first hex-side 611 may not be linearly straight as depicted in FIG. 6, but instead may be curved, either into or away from the segment of material. In some embodiments, third hex-side 613 and/or fifth hex-side 615 may not be linearly straight as depicted in FIG. 6, but instead may be curved, either into or away from the segment of material.

In some embodiments, sixth hex-side 616 and second hex-side 612 may be longer than fourth hex-side 614 (this embodiment not depicted in the figures). In some embodiments, third hex-side 613 and fifth hex-side 615 may be longer than fourth hex-side 614 (this embodiment not depicted in the figures).

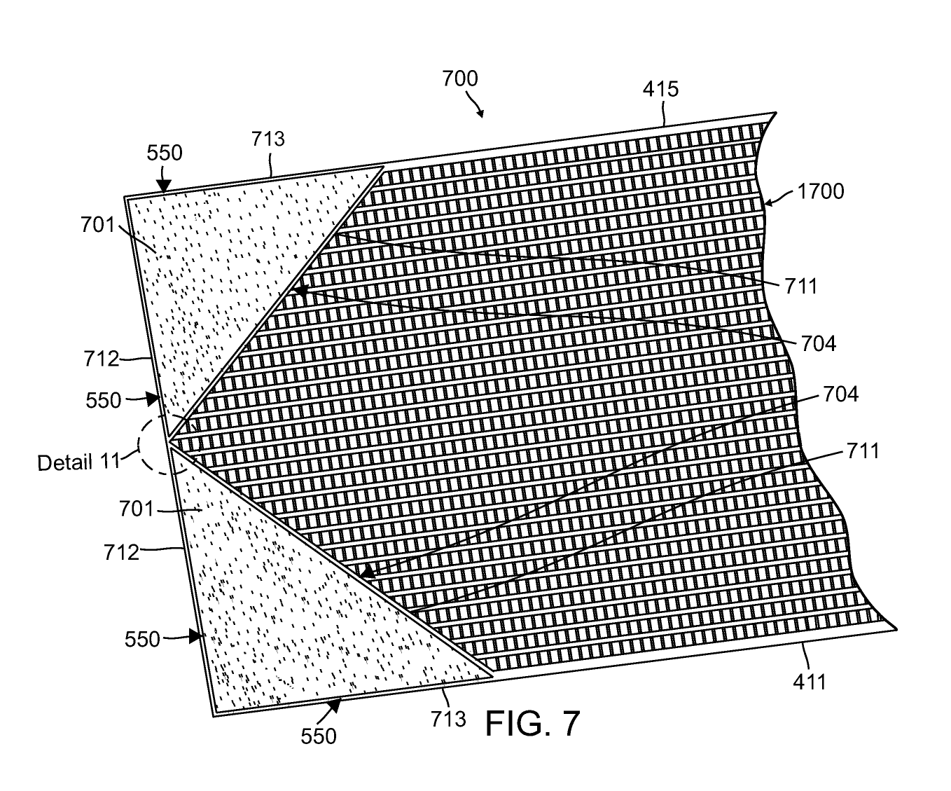

In some embodiments, the segment of material (e.g., 501) may be substantially shaped as a triangle (e.g., a right triangle) and wherein the cover (e.g., cover 200 or cover 600) may be an octagon shape. In such embodiments, such a triangle may comprise a first tri-side, a second tri-side, and a third tri-side. In some embodiments, the second tri-side may be attached to either third edge 413 or seventh edge 417 by the means for attaching 550. In this embodiment, this second tri-side may be the second end of the segment of material. In some embodiments, the third tri-side may be attached to either first edge 411 or to fifth edge 415 by means for attaching 550. In this embodiment, this third tri-side may be the first end of the segment of material. In some embodiments, the first tri-edge and a portion of second surface 402 covered by the first tri-edge may form a single opening to an article corner cavity. In some embodiments, the article corner cavity may be shaped to accommodate single corner 1702 of article 1700. Note, the embodiments described in this paragraph may be similar to embodiments depicted in FIG. 7; however, in FIG. 7, cover 700 may have a rectangular shape and not the octagon shape.

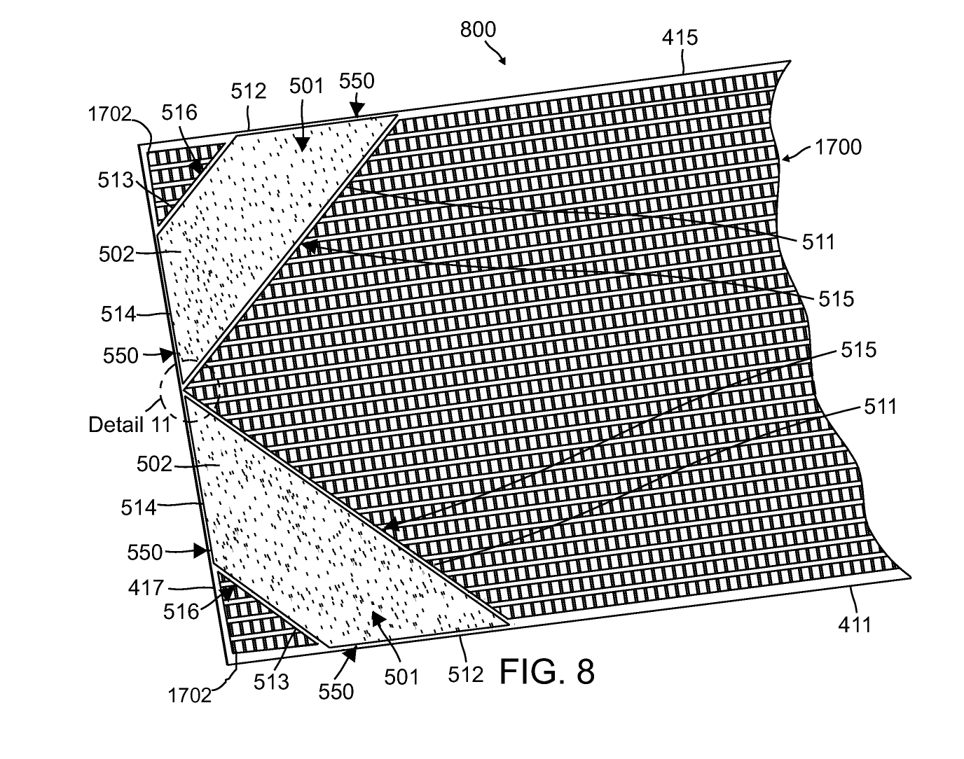

Note, FIG. 7 and FIG. 8 may reflect a cover (700 and 800 respectively) with a different shape than the octagon shape of cover 200 in FIG. 2A through FIG. 6. Instead of the octagon shape, the cover shape, i.e., the planar shape of the cover, (as viewed from above if the cover were lying flat up the substrate) in FIG. 7 and in FIG. 8 may be rectangular.

In some embodiments, the planar shape of cover 700 and the planar shape of cover 800 may each be substantially shaped as a planar rectangular shape (as viewed from above if the cover were lying flat up the substrate). In some embodiments, cover 700 and cover 800 may each comprise first edge 411, third edge 413, fifth edge 415, and seventh edge 417. In some embodiments, first edge 411 may connect to third edge 413; where third edge 413 may then connect to fifth edge 415; where fifth edge 415 may then connect to seventh edge 417; and finally where seventh edge 417 may then connect to first edge 411. In some embodiments, first edge 411 may be substantially parallel with fifth edge 415. In some embodiments, third edge 413 may be substantially parallel with seventh edge 417. In some embodiments, first edge 411 and fifth edge 415 may be longitudinal edges (longer edges). In some embodiments, third edge 413 and seventh edge 417 may be transverse edges (shorter edges). These transverse edges may be substantially perpendicular to the longitudinal edges. See e.g., FIG. 7 and FIG. 8.

FIG. 7 may depict an alternative embodiment of the cover, that of cover 700, which may employ a different segment-planar-shape, a triangle, than disclosed in FIG. 2A through FIG. 6, shown from a bottom perspective view.

In some embodiments, the segment-planar-shape of segment of material 501 may be substantially shaped as a triangle (e.g., a right triangle) and denoted as triangle segment of material 701 in FIG. 7. In some embodiments, triangle segment of material 701 may comprise a first tri-side 711, a second tri-side 712, and a third tri-side 713; wherein these three sides form the boundary of the triangle. In some embodiments, second tri-side 712 may be attached to either third edge 413 or the seventh edge 417 by the means for attaching 550. Note, seventh edge 417 and third edge 413 are not explicitly called out in FIG. 7, as seventh edge 417 or third edge 413 would be directly under second tri-side 712 and joined together by means for attaching 550 (such as seam 550). In some embodiments, second tri-side 712 may the second end of the segment of material. In some embodiments, third tri-side 713 may be attached to either first edge 411 or fifth edge 415 by means for attaching 550. In some embodiments, third tri-side 713 may be the first end of the segment of material. In some embodiments, first tri-side 711 and a portion of second surface 402 covered by first tri-side 711 may form a single opening 704 to an article corner cavity. The article corner cavity may be shaped to removably accommodate a single corner 1702 of article 1700 within the article corner cavity. See e.g., FIG. 7. In some embodiments of cover 700, there may be one such triangle segment of material 701 for each corner 1702 of article 1700. Thus, when article 1700 have may four corners 1702, then cover 700 may comprise four triangle segments of material 701. FIG. 7 may depict two such triangle segments of material 701.

FIG. 8 may depict an alternative planar shape for the cover, that of cover 800, as compared against the covers (e.g., cover 200 and cover 600) depicted in FIG. 2A through FIG. 6, shown from a bottom perspective view. For example, and without limiting the scope of the present invention, in some embodiments, the planar shape of cover 800 may each be substantially shaped as a planar rectangular shape (as viewed from above if the cover were lying flat up the substrate). This may mean, from a top view, that article 1700 corners 1702 may be substantially covered with complimentary corners of cover 800; or as viewed from the bottom perspective view as in FIG. 8, corners 1702 may be resting upon such cover 800 complimentary corners, which may be different as compared against FIG. 5.

In some embodiments, the segment-planar-shape of segment of material 501 may be substantially shaped as a trapezoid (e.g. an isosceles trapezoid or a scalene trapezoid). In some embodiments, this trapezoid segment of material 501 may comprise first trap-side 511, second trap-side 512, third trap-side 513, and fourth trap-side 514. In some embodiments, second trap-side 512 may be attached to either first edge 411 or fifth edge 415 by means for attaching 550. In some embodiments, second trap-side 512 may the first end of the segment of material 501. In some embodiments, fourth trap-side 514 may be attached to either third edge 413 or seventh edge 417 by means for attaching 550. Portions of seventh edge 417 and third edge 413 may be directly under fourth trap-side 514 and joined together by means for attaching 550 (such as seam 550). In some embodiments, fourth trap-side 514 may be the second end of segment of material 501. In some embodiments, attachment of this trapezoid segment of material 501 to cover 800 may form the hollow tube and/or the bridge. In some embodiments, the hollow tube and/or the bridge may comprise two openings, larger opening 515 and smaller opening 516. In some embodiments, the hollow tube and/or the bridge may be configured to accommodate removable passage of single article corner 1702 through larger opening 515 and through smaller opening 516. In some embodiments, first trap-side 511 and a portion of the second surface 402 covered by first trap-side 511 may form larger opening 515. In some embodiments, third trap-side 513 and a portion of second surface 402 covered by third trap-side 513 may form smaller opening 516. See e.g., FIG. 8.

In some embodiments, first trap-side 511 may be longer than the other three sides (512, 513, and 514). See e.g., FIG. 8. In some embodiments, first trap-side 511 may be longer than the other three sides and wherein first trap-side 511 may be substantially parallel with third trap-side 513, such that the trapezoid may be an isosceles trapezoid. See e.g., FIG. 8. In some embodiments, second trap-side 512 and fourth trap-side 514 may be substantially a same dimension. See e.g., FIG. 8.

In some embodiments of cover 800, there may be one such trapezoid segment of material 501 for each corner 1702. Thus, when article 1700 may have four corners 1702, then cover 800 may comprise four trapezoid segments of material 501.

In some embodiments, second trap-side 512 and fourth trap-side 514 may be different dimensions such that the trapezoid may be a scalene trapezoid. While such scalene trapezoids may be not be depicted in the figures, such trapezoids are contemplated as within the scope of the invention and should fall within the skill of an ordinary practitioner of this art.

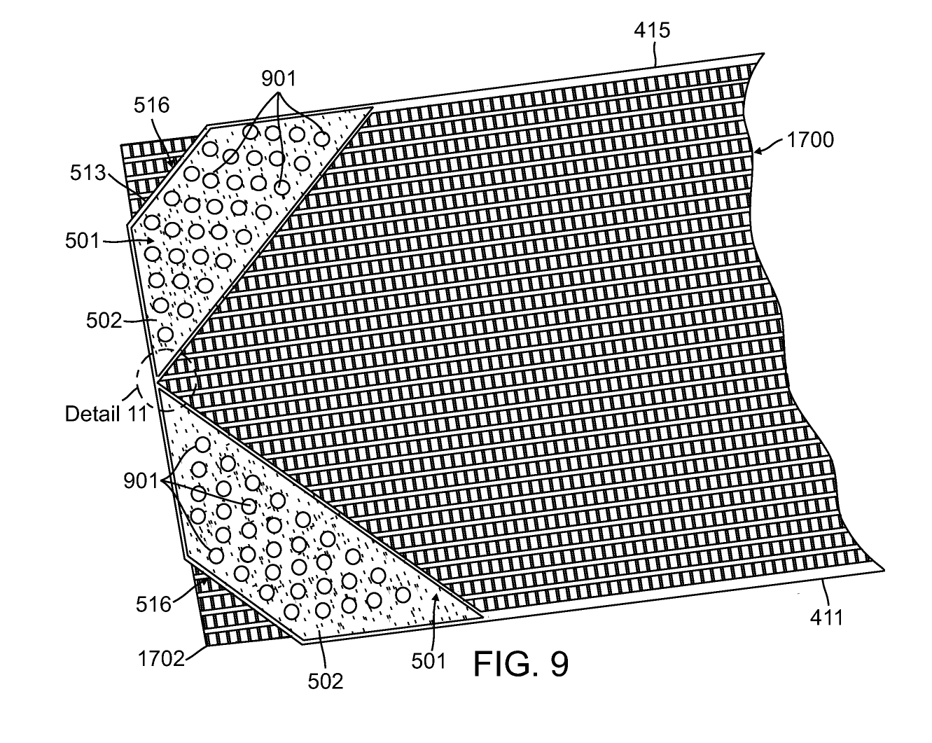

FIG. 9 may depict a cover 900 embodiment that may comprise an anti-slip means 901, wherein cover 900 may be removably attached to article 1700, shown from a bottom perspective view. FIG. 9 may be similar to FIG. 5, except in FIG. 9, cover 900 may comprise anti-slip means 901. Note, anti-slip means 901 may be an additional anti-slip means that is in addition to the article attachment means.

In some embodiments, segment of material 501 may comprise exterior surface 502. When cover 900 (or other cover embodiments, such as but not limited to cover 200, cover 600, cover 700, cover 800, and cover 1000) may be in use with article 1700, at least some portion of exterior surface 502 may be in removable contact with the substrate. In some embodiments, the substrate may support article 1700, cover 900 (or other cover embodiment, such as but not limited to cover 200, cover 600, cover 700, cover 800, and cover 1000), and/or user 1900. In some embodiments, the substrate may be a floor, a ground, or similar surface. It may be desirable that article 1700 does not slip against the substrate. For example, when article 1700 may comprise a yoga mat and/or a Pilates mat, such mats 1700 may be primarily designed to mitigate against slippage between the mat 1700 and the substrate. It may also be desirable that portions of cover 900 (or other cover embodiments), such as exterior surface 502, in removable contact with the substrate also do not slip against the substrate. Also because yoga mats 1700 and/or Pilates mats 1700 may be primarily designed to mitigate against substrate slippage, it may be desirable to minimize surface area of exterior surface 502.

In some embodiments, exterior surface 502 may comprise anti-slip means 901. In some embodiments, anti-slip means 901 may be located on exterior surface 502. In some embodiments, anti-slip means 901 may be attached to (e.g. adhered to) exterior surface 502. In some embodiments, anti-slip means 901 may comprise at least one region of tacky material attached to exterior surface 502 of segment of material 501. In some embodiments, tacky materials may be selected from one or more elastomeric materials such as silicones, rubbers, soft durometer plastics, and/or the like. The tacky material itself may provide some anti-slip properties and its structural and geometric arrangement may also provide some anti-slip properties.

For example, and without limiting the scope of the present invention, one region of tacky material may be a hemispherical shaped material such as a silicone hemisphere, wherein a flat portion of the hemisphere may be adhered to exterior surface 502 of segment of material 501. In some embodiments, the shape of the tacky material may be other than hemispherical.

For example, and without limiting the scope of the present invention, the shape may be a continuous or dis-continuous bead of tacky material. In some embodiments, the at least one region of tacky material may be a plurality of regions of tacky material; wherein such a plurality may be arranged randomly or in various patterns. See e.g., FIG. 9, wherein anti-slip means 901 may comprise a plurality of regions of tacky material.

Note anti-slip means 901 (attached to exterior surface 502), may also be utilized in other embodiments, such as cover 600, cover 700, cover 800, cover 1000 and other cover embodiments.

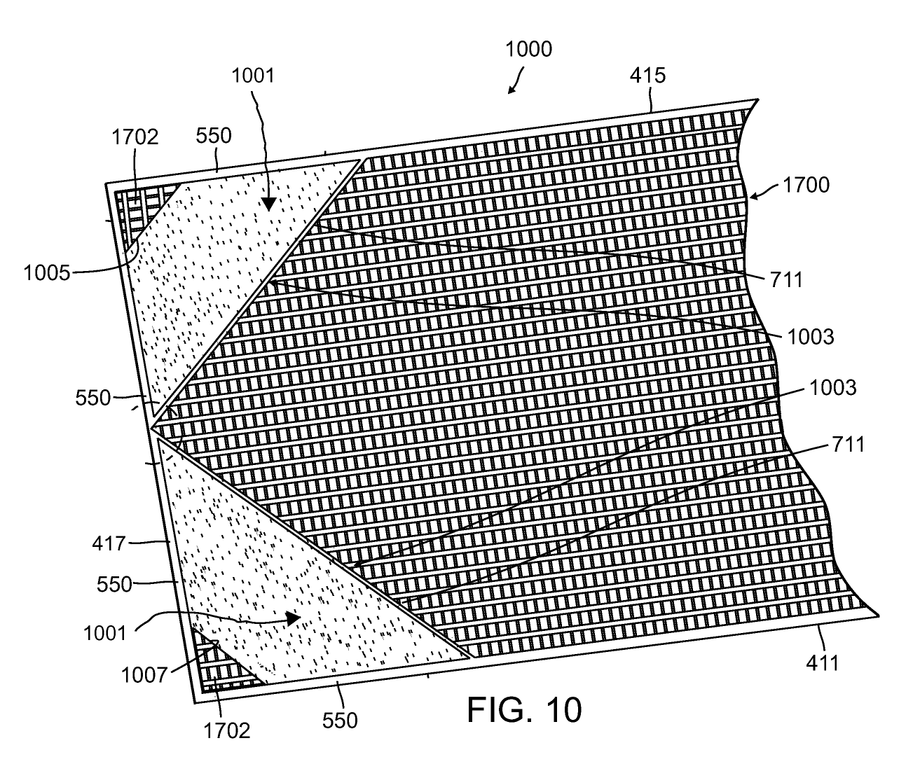

FIG. 10 may depict at least two alternative article attachment means embodiments, one operating at each of two corners 1702 of article 1700 being removably held by a cover 1000, shown from a bottom perspective view.

In some embodiments, an embodiment substantially equivalent to that depicted in FIG. 8 may be formed without use of a separate segment of material 501. See e.g., FIG. 10. Instead in FIG. 10, a substantially equivalent structure may be formed by starting with substantially rectangular cover 800 and then making two parallel slits where first trap-side 511 and third trap-side 513 would be had trapezoidal segment of material 501 been attached to cover 800 as noted above in the FIG. 8 discussion. A first of these two parallel slits may form first longer slit 1003, which may be substantially equivalent to larger opening 515 in FIG. 8. In FIG. 10 first longer slit 1003 may be located where larger opening 515 in FIG. 8 may be located. A second of these two parallel slits may be second shorter slit 1005. Second shorter slit 1005 may be located in a comparable location as that of 513 in FIG. 8. Having made these two parallel slits (1003 and 1005) in cover 1000, then single corner 1702 of article 1700 may passed removably through the two slits. Seams around each slit (1003 and 1005) may be sealed as discussed above via various hem means and/or by means for attaching 550.

In some embodiments, an embodiment substantially equivalent to that depicted in FIG. 8 may be formed from modifying the embodiment depicted in FIG. 7. This may be done in at least two different ways.

In one modification of the embodiment depicted in FIG. 7, a smaller concentric triangle shape, triangle opening 1007, that may smaller than that of the triangle shape of segment of material 701 of FIG. 7, may be cut out from the triangle shape of segment of material 701 of FIG. 7 such that the resulting structure may be substantially equivalent to the embodiment depicted in FIG. 8. Single corner 1702 of article 1700 may be removably pulled through the smaller concentric triangle cutout of triangle opening 1007. See e.g., FIG. 10.

In a second modification of the embodiment depicted in FIG. 7, a slit, second shorter slit 1005, may be made in the triangle shape of segment of material 701 of FIG. 7, wherein second shorter slit 1005 may be parallel to first tri-side 711 and approximating third trap-side 513 in terms of slit length and location, such that the resulting structure may be substantially equivalent to the embodiment depicted in FIG. 8. Single corner 1702 of article 1700 may be removably pulled through the cut second shorter slit 1005. See e.g., FIG. 10.

And seams around first longer slit 1003, second shorter slit 1005, and triangle opening 1007 may be sealed as discussed above via various hem means and/or by means for attaching 550.

When article 1700 may have four corners 1702, then in some embodiments, cover 1000 may comprise four pairs of slits 1003 and 1005. See e.g., FIG. 10 (although FIG. 10 may only depict one pair of slits 1003 and 1005). When article 1700 may have four corners 1702, then in some embodiments, cover 1000 may comprise four triangle opening 1007. See e.g., FIG. 10 (although FIG. 10 may only depict one triangle opening 1007).

When article 1700 may have four corners 1702, then in some embodiments, cover 1000 may comprise four triangle segment of material 701, each triangle segment of material 701 with one second shorter slit 1005. When article 1700 may have four corners 1702, then in some embodiments, cover 1000 may comprise four triangle segment of material 701, each triangle segment of material 701 with one triangle opening 1007.

FIG. 11 may depict a close up view of DETAIL 11, wherein DETAIL 11 may be shown in FIG. 5 and in FIG. 7 through FIG. 10. DETAIL 11 may focus on a single terminal end region of some cover embodiments (such as 200, 700, 800, and 900) where two different segments of material 501 (or triangle segment of material 701) may terminate at a shared point or shared region on seventh edge 417 or on third edge 413. In FIG. 11, this shared point or shared region may be denoted by reference numeral 1101 and may be a region of overlap, as in overlap 1101. Overlap 1101 may be provide for an increase in structural strength.

However, in some embodiments, this shared point or shared region may be non-overlapping. For example, and without limiting the scope of the present invention, DETAIL 11 in FIG. 5, FIG. 7, FIG. 8, and/or FIG. 9 may be non-overlapping. Whereas, in other embodiments, DETAIL 11 in FIG. 5, FIG. 7, FIG. 8, and/or FIG. 9 may be overlapping as depicted in the close up of DETAIL 11 depicted in FIG. 11.

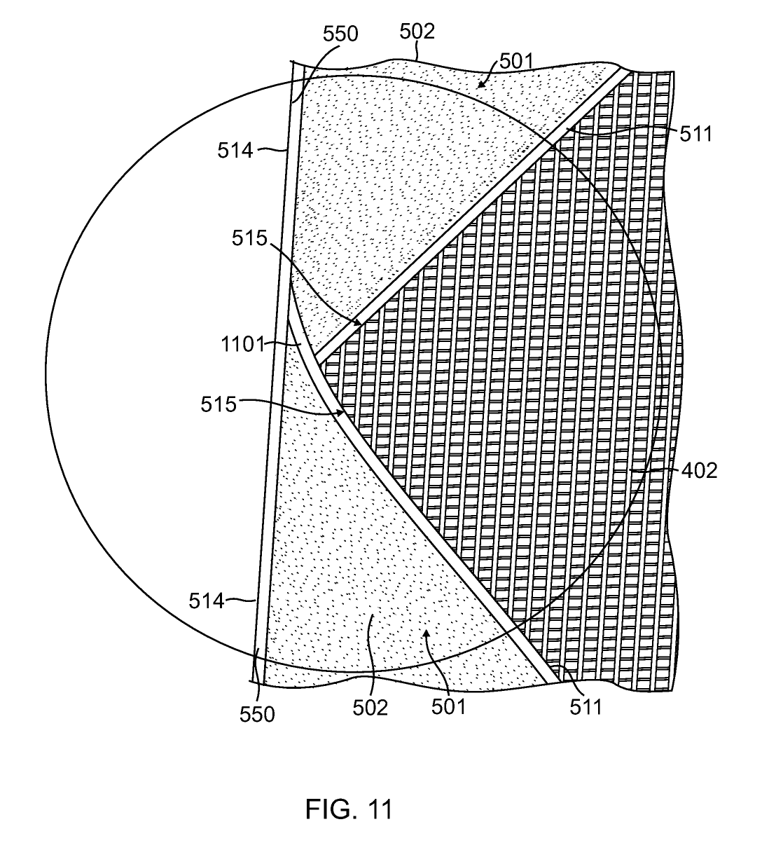

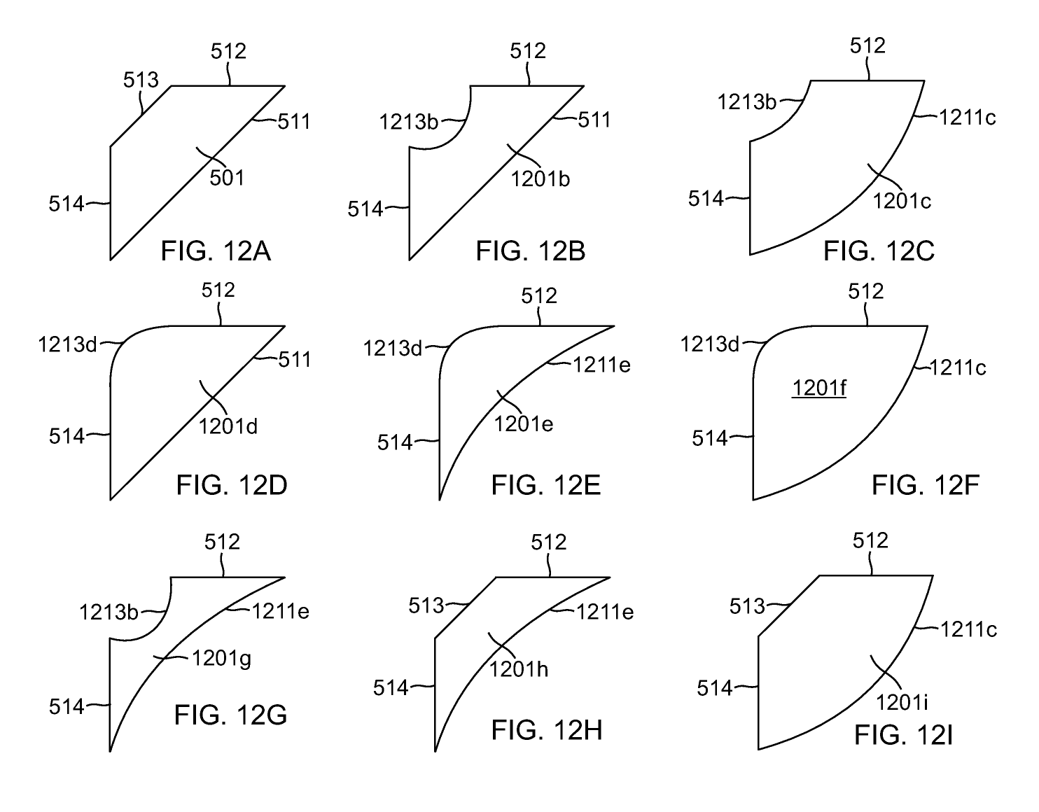

FIG. 12A through FIG. 12I may depict various different geometric two dimensional (2D) shapes for various segment-planar-shapes, as viewed from the bottom or from above, for a given segment of material, such as variations on segment of material 501; wherein each of these segments of materials may be an external component of a given article attachment means.

FIG. 12A may depict bottom exterior view of segment of material 501, which may also be shown in FIG. 4C, FIG. 5, FIG. 8, and FIG. 9. This embodiment of segment of material 501 may be the isosceles trapezoid shape for the segment-planar-shape. In some embodiments, the segment-planar-shape for segment of material 501 may be the scalene trapezoid, which may not be depicted.

FIG. 12B through and including FIG. 12I may depict eight variations on the trapezoid segment-planar-shape of segment of material 501 depicted in FIG. 12A, FIG. 4C, FIG. 5, FIG. 8, and FIG. 9.

FIG. 12B may depict segment of material 1201b, where curved third trap-side 1213b may have replaced third trap-side 513. The curve of third trap-side 1213b may curve into segment of material 1201b. Otherwise, segment of material 1201b may comprise first trapside 511, second trap-side 512, and fourth trap-side 514.

FIG. 12C may depict segment of material 1201c, where curved third trap-side 1213b may have replaced third trap-side 513 and curved first trap-side 1211c may have replaced first trap-side 511. The curve of third trap-side 1213b may curve into segment of material 1201c. The curve of first trap-side 1211c may curve away from segment of material 1201c. Otherwise, segment of material 1201c may comprise second trap-side 512 and fourth trap-side 514.

FIG. 12D may depict segment of material 1201d, where curved third trap-side 1213d may have replaced third trap-side 513. The curve of third trap-side 1213d may curve away from segment of material 1201d. Otherwise, segment of material 1201d may comprise first trap-side 511, second trap-side 512, and fourth trap-side 514.

FIG. 12E may depict segment of material 1201e, where curved third trap-side 1213d may have replaced third trap-side 513 and curved first trap-side 1211e may have replaced first trap-side 511. The curve of third trap-side 1213d may curve away from segment of material 1201e. The curve of first trap-side 1211e may curve into segment of material 1201e. Otherwise, segment of material 1201e may comprise second trap-side 512 and fourth trap-side 514.

FIG. 12F may depict segment of material 1201f, where curved third trap-side 1213d may have replaced third trap-side 513 and curved first trap-side 1211c may have replaced first trap-side 511. The curve of third trap-side 1213d may curve away from segment of material 1201f. The curve of first trap-side 1211c may curve away from segment of material 1201f. Otherwise, segment of material 1201f may comprise second trap-side 512 and fourth trap-side 514.

FIG. 12G may depict segment of material 1201g, where curved third trap-side 1213b may have replaced third trap-side 513 and curved first trap-side 1211e may have replaced first trap-side 511. The curve of third trap-side 1213b may curve into segment of material 1201g. The curve of first trap-side 1211e may curve into segment of material 1201g. Otherwise, segment of material 1201g may comprise second trap-side 512 and fourth trap-side 514.

FIG. 12H may depict segment of material 1201h, where curved first trap-side 1211e may have replaced first trap-side 511. The curve of first trap-side 1211e may curve into segment of material 1201h. Otherwise, segment of material 1201h may comprise second trapside 512, third trap-side 513, and fourth trap-side 514.

FIG. 12I may depict segment of material 1201i, where curved first trap-side 1211c may have replaced first trap-side 511. The curve of first trap-side 1211c may curve away from segment of material 1201i. Otherwise, segment of material 1201i may comprise second trapside 512, third trap-side 513, and fourth trap-side 514.

Note references to first trap-side 511, second trap-side 512, third trap-side 513, and/or fourth trap-side 514 in the above noted segments of materials 1201 may be structurally and/or functionally equivalent to first trap-side 511, second trap-side 512, third trap-side 513, and/or fourth trap-side 514 in segment of material 501. Note references to first trap-side 1211 and/or third trap-side 1213 that may be replacing first trap-side 511 and/or third trap-side 513, respectively, in the above noted segments of materials 1201 may be structurally similar and/or functionally equivalent to first trap-side 511 and third trap-side 513 in segment of material 501.

In some exemplary embodiments, it may be desirable to mitigate against slippage with respect to the cover and article 1700 being removably held by the cover. As noted above, in some embodiments, attachment of the segment of material 501 (or segment of material 1201 or triangle segment of material 701) to various embodiments of the cover (e.g., 200, 600, 700, 800, and 900) by the means for attaching 550 may form either the hollow tube and/or the bridge (see e.g., FIG. 5, FIG. 6, FIG. 8, and FIG. 9) or the cavity (see e.g. FIG. 7). In such embodiments, segment of material 501 (or segment of material 1201 or triangle segment of material 701) may comprise an interior surface facing a portion of second surface 402 covered by segment of material 501 (or segment of material 1201 or triangle segment of material 701). This interior surface may be disposed opposite of exterior surface 502. In some embodiments, the structure of the hollow tube, the bridge, and/or the cavity may be sufficient to mitigate against slippage with respect to the cover and article terminal end 1701 and/or article corner 1702 of article 1700 being removably held by the hollow tube, the bridge, and/or the cavity.

In some embodiments, anti-slippage with respect to the cover and article terminal end 1701 and/or article corner 1702 of article 1700 being removably held by the hollow tube, the bridge, and/or within the cavity may be increased by an additional article-anti-slip means. In some embodiments, the article-anti-slip means may be located within the hollow tube, the interior of the bridge, and/or within the cavity. In some embodiments, the article-anti-slip means may comprise at least one region of tacky material attached to the interior surface of segment of material 501 (or segment of material 1201 or triangle segment of material 701) and/or attached to the portion of second surface 402 covered by segment of material 501 (or covered by segment of material 1201 or triangle segment of material 701). In some embodiments, the article-anti-slip means may comprise at least one region of friction generating material attached to the interior surface of segment of material 501 (or segment of material 1201 or triangle segment of material 701) and/or attached to the portion of second surface 402 covered by segment of material 501 (or segment of material 1201 or triangle segment of material 701). In some embodiments, the friction generating material may be the tacky material. In some embodiments, this tacky material may be anti-slip means 901. In some embodiments, the friction generating material may be a plurality of plastic and/or metal teeth configured increase friction between a portion of article 1700 removably passing through the hollow tube, under the bridge, and/or being removably held within the cavity. Such teeth may be angled to facilitate easy movement of the portion of article 1700 into the hollow tube, into the bridge, and/or into the cavity, but tends to make movement back out of the hollow tube, the bridge, and/or the cavity more difficult.

In some embodiments, an embodiment of the cover (e.g. 200, 600, 700, 800, 900, and 1000) may comprise two towel terminal ends disposed opposite of each other across longitudinal length 303. In some embodiments, the two towel terminal ends may be either third edge 413 or seventh edge 417. In some exemplary embodiments, each segment of material 501 (or segment of material 1201 or triangle segment of material 701) may be located such that at least a portion of segment of material 501 (or segment of material 1201 or triangle segment of material 701) may be in physical contact (e.g., attached to) with one of the two towel terminal ends of the cover. See e.g. FIG. 5 and FIG. 4C. In some embodiments, each segment of material 501 (or segment of material 1201 or triangle segment of material 701) may be located within a fixed distance of one of the two towel terminal ends, wherein the fixed distance may be less than transverse width 304 of the cover.

For example, and without limiting the scope of the present invention, in some embodiments, there may be two segments of material 501, each in the strip embodiment configuration (i.e., the band, wherein the bands spans from first edge 411 to fifth edge 415, with terminal ends of the strip attached at first edge 411 and fifth edge 415). In some embodiments, one longitudinal edge of each strip may be located at first edge 411 and the other at fifth edge 415. In some embodiments, each strip may be located at the fixed distance of 0.25 inches to 20 inches from one of the two terminals end of the cover, with one such strip may be associated with one terminal end of the cover. In some embodiments, each strip may be located within a fixed distance of eleven inches from one of the two terminals end of the cover. Of course, other fixed distances may be used in other embodiments.

In some embodiments of the cover, there may be one segment of material 501 (or segment of material 1201 or triangle segment of material 701) for each corner 1702 of article 1700. See e.g., FIG. 4C, where cover 200 may comprise four segments of materials 501 to accommodate article 1700 with four corners 1702. And see FIG. 5 where two of the four segments of material 501 may be depicted removably holding two corners 1702 of article 1700. In some embodiments of the cover, there may be one segment of material 501 associated with each terminal end of the cover. See e.g., FIG. 6. In some embodiments of the cover, there may be either: one, two, three, four or more segments of material 501 (or segment of material 1201 or triangle segment of material 701). However, at a point, a certain quantity of segments of material 501 (or segment of material 1201 or triangle segment of material 701) may become impracticable, as adding too many may create problems removably attaching and/or detaching article 1700 to the cover (such as taking too long and/or becoming cumbersome). It may be contemplated that some embodiments may comprise twelve to two segments of material 501 (or segment of material 1201 or triangle segment of material 701). Each such segment of material 501 (or segment of material 1201 or triangle segment of material 701) may have either a same shape or a different shape. Some segment-planar-shapes of segment of material 501 may be: regular polygons, with or without rounded corners; irregular polygons, with or without rounded corners; semi-circles; semi-ellipses; ellipses; a circles; a rectangles, with or without rounded corners; trapezoids, with or without rounded corners; hexagons, with or without rounded corners; triangles, with or without rounded corners (e.g., triangle segment of material 701 and/or right triangles); ovals; diamonds, with or without rounded corners; elongate members; strips; bands; sinuous strips; combinations thereof; and/or the like.

In some embodiments, from a manufacturing perspective, segment of material 501 (or segment of material 1201 or triangle segment of material 701) and a given cover embodiment may not be separate articles of manufacture. Instead, in some embodiments, segment of material 501 (or segment of material 1201 or triangle segment of material 701) and a given cover embodiment may be a single article of manufacture. In such embodiments, segment of material 501 (or segment of material 1201 or triangle segment of material 701) and a given cover embodiment may be die cut from a larger piece of material. The die cut cutout material of segment of material 501 (or segment of material 1201 or triangle segment of material 701) and a given cover embodiment may have an overall shape that may be substantially the shape of that cover embodiment, e.g. octagon or rectangular, but with integrally connected flaps coming off of the cover shape (octagon or rectangular) at certain edges, wherein the flaps may be segments of material 501 (or segment of material 1201 or triangle segment of material 701). Such flaps may then be folded over and attached to the cover at a perpendicular edge or a parallel edge via means for attaching 550, to form either the hollow tube, the bridge, and/or the cavity.

Whereas, in other manufacturing embodiments, segments of material 501 (or segment of material 1201 or triangle segment of material 701) and the cover may begin as separate articles of manufacture, wherein the separate segments of material 501 (or segment of material 1201 or triangle segment of material 701) may then be attached to the cover via means for attaching 550 during assembly.

In some embodiments, a system for protecting article 1700 may comprise: article 1700 and the cover (i.e., in various embodiments the cover may be: 200, 600, 700, 800, 900, and/or 1000). In some embodiments, a system for minimizing slippage between article 1700 and the cover (i.e., in various embodiments the cover may be: 200, 600, 700, 800, 900, and/or 1000) that are used together may comprise article 1700 and the cover (e.g., 200, 600, 700, 800, 900, and/or 1000).

As noted, in some embodiments, article 1700 may be selected from an exercise mat, a Pilates mat, a yoga mat, a stretching mat, and/or the like. As noted, in some embodiments, article 1700 may be a personal exercise mat and/or the like. And the various cover embodiments (e.g., 200, 600, 700, 800, 900, and/or 1000) may be as described as per above, in the various cover embodiments.

Note with respect to possible disclosed materials of construction, it is not desired nor intended to thereby unnecessarily limit the present invention by reason of such restricted disclosure.

Various covers, such as a towel or a towel like structure, for at least partially covering an article, such as a mat, a yoga mat, an exercise mat, a personal exercise mat, and/or a Pilates mat, have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A cover for use with an article that substantially covers the article, the cover comprising:
a first surface, wherein when the cover is in use with the article and a user, at least a portion of the first surface is in removable physical contact with the user;
a second surface, wherein the second surface is disposed opposite of the first surface and separated from the first surface by a cover thickness; wherein when the cover is in use with the article, at least some portion of the second surface is in substantial physical contact with the article;
at least one edge; wherein the at least one edge circumscribes the first surface and the second surface substantially forming a planar shape; and
an article attachment means; wherein at least a portion of the article attachment means is attached to at least a portion of the at least one edge; wherein the article attachment means removably attaches at least one portion of the article to the cover, such that slippage between the article and the cover is minimized.

2. The cover for use with the article according to claim 1, wherein the first surface, the second surface, the cover thickness, and the article attachment means are all substantially constructed of one or more of: a flexible material, a planar material, a fabric material, or a soft material.

3. The cover for use with the article according to claim 1, wherein the first surface, the second surface, the cover thickness, and the article attachment means are all substantially constructed of a fabric material, wherein the fabric material comprises one or more properties consisting of: flexibility, softness, moisture absorbing, mildew resistant, durable against machine washing, or durable against the user performing exercises while on top of the cover.

4. The cover for use with the article according to claim 1, wherein the first surface, the second surface, and the cover thickness are all integral with respect to each other as a single article of manufacture.

5. The cover for use with the article according to claim 1, wherein the at least one edge comprises at least four edges that together substantially circumscribe the planar shape; wherein these four edges comprise: a first edge, a third edge, a fifth edge, and a seventh edge; wherein the first edge is disposed opposite from the fifth edge and the third edge is disposed opposite of the seventh edge.

6. The cover for use with the article according to claim 5, wherein the planar shape is a planar rectangular shape; wherein the first edge is substantially parallel with the fifth edge; and wherein the third edge is substantially parallel with the seventh edge.

7. The cover for use with the article according to claim 5, wherein the planar shape is substantially shaped as a planar octagon formed from the at least one edge comprising eight edges that together circumscribe the planar octagon; wherein these eight edges are the first edge, a second edge, the third edge, a fourth edge, the fifth edge, a sixth edge, the seventh edge, and an eighth edge; wherein the first edge is substantially parallel with the fifth edge; wherein the second edge is substantially parallel with the sixth edge; wherein the third edge is substantially parallel with the seventh edge; wherein the fourth edge is substantially parallel with the eighth edge.

8. The cover for use with the article according to claim 5, wherein the article attachment means comprises at least one segment of material and a means for attaching the at least one segment of material to the at least the portion of the at least one edge.

9. The cover for use with the article according to claim 8, wherein the means for attaching the at least one segment of material to the cover is selected from one or more of the group consisting of: sewn stitching, ultrasonic welding, heat welding, chemical adhesive, solvent bonding, or other mechanical fasteners.

10. The cover for use with the article according to claim 8, wherein the at least one segment of material is substantially constructed of a same material of construction used to substantially construct the first surface, the second surface, or the cover thickness.

11. The cover for use with the article according to claim 8, wherein the at least one segment of material is substantially planar and has a same thickness as the cover thickness.

12. The cover for use with the article according to claim 8, wherein the at least one segment of material has a segment-planar-shape selected from one or more of the following: a regular polygon, an irregular polygon, a semi-circle, a semi-ellipse, an ellipse, a circle, a rectangle, a trapezoid, a hexagon, a triangle, an elongate member, or combinations thereof.

13. The cover for use with the article according to claim 8, wherein the at least one segment of material comprises at least two ends, a first end and a second end; wherein the first end is attached to the first edge and the second end is attached to the fifth end; wherein such attachment is by the means for attaching.

14. The cover for use with the article according to claim 8, wherein the at least one segment of material comprises at least two ends, a first end and a second end; wherein the first end is attached to either the first edge or the fifth edge; and the second end is attached to either the third edge or the seventh edge; wherein such attachment is by the means for attaching; wherein this results in the at least one segment of material covering a portion of the second surface.

15. The cover for use with the article according to claim 14, wherein the first end is one end or one edge of a segment-planar-shape of the at least one segment of material selected from one or more of the following: a regular polygon, an irregular polygon, a semi-circle, a semi-ellipse, an ellipse, a circle, a rectangle, a trapezoid, a hexagon, an elongate member, or combinations thereof; and the second end is a different end or different of edge of this segment-planar-shape.

15. The cover for use with the article according to claim 14, wherein attachment of the at least one segment of material to the cover by the means for attaching forms either a hollow tube or a cavity; wherein the hollow tube or the cavity is substantially bound by an interior surface of the at least one segment of material and the portion of the second surface that is covered by the at least one segment of material; wherein the hollow tube or the cavity is an article-anti-slip means such that the hollow tube or the cavity removably accepts a portion of the article through the hollow tube or within the cavity that minimizes slippage between the article and the cover.

16. The cover for use with the article according to claim 8, wherein the at least one segment of material comprises an exterior surface, wherein when the cover is in use with the article, at least some portion of the exterior surface is in removable contact with a substrate; wherein the substrate supports the article, the cover, and the user.

17. The cover for use with the article according to claim 8, wherein the article attachment means comprises one segment of material for each corner of the article or for each pair of corners of the article.

18. A towel that removably attaches to a personal exercise mat and that substantially covers the personal exercise mat such that slippage between the towel and the personal exercise mat is minimized; wherein the towel comprises:
a flexible, soft, and planar member comprising an upper surface disposed opposite of a bottom surface by a cover thickness; wherein the upper surface removably engages a user and portions of the bottom surface are in substantial physical contact with the personal exercise mat;
at least one edge; wherein the at least one edge circumscribes the upper surface and the bottom surface forming the towel into a planar shape; and
a personal exercise mat attachment means; wherein the personal exercise attachment means comprises at least one segment of material and a means for attaching the at least one segment of material to the at least two different regions of the at least one edge such that either a hollow tube or a cavity is formed by the at least one segment of material covering over a portion of the bottom surface; wherein the hollow tube or the cavity is a personal-exercise-mat-anti-slip means such that the hollow tube or the cavity removably accepts at least one corner of the personal exercise mat through the hollow tube or within the cavity such that slippage is minimized between the towel and the personal exercise mat.

19. A system for minimizing slippage between an article and a cover that are used together; wherein the system comprises:
the article, wherein the article is selected from one or more of the following: an exercise mat, a Pilates mat, or a yoga mat;
one cover for each of the articles, wherein the cover comprises:
a first surface, wherein when the cover is in use with the article and a user, at least a portion of the first surface is in removable physical contact with the user;
a second surface, wherein the second surface is disposed opposite of the first surface and separated from the first surface by a cover thickness; wherein when the cover is in use with the article, at least some portion of the second surface is in substantial physical contact with the article;
at least one edge; wherein the at least one edge circumscribes the first surface and the second surface substantially forming a planar shape; and
an article attachment means; wherein at least a portion of the article attachment means is attached to at least a portion of the at least one edge; wherein the article attachment means removably attaches at least one portion of the article to the cover, such that slippage between the article and the cover is minimized.
